(19) United States
(12) Patent Application Publication
(10) Pub. No.: US 2013/0063863 A1
(43) Pub. Date: Mar. 14, 2013

(54) Insulator Based Upon One or More Dielectric Structures

(71) Applicants: John P. Timler, Bloomfield, IN (US); David A. Baldwin, Annandale, VA (US)

(72) Inventors: John P. Timler, Bloomfield, IN (US); David A. Baldwin, Annandale, VA (US)

(21) Appl. No.: 13/544,717

(22) Filed: Jul. 9, 2012

Related U.S. Application Data
(60) Provisional application No. 61/505,862, filed on Jul. 8, 2011.
(60) Provisional application No. 61/505,855, filed on Jul. 8, 2011.
(60) Provisional application No. 61/505,842, filed on Jul. 8, 2011.
(60) Provisional application No. 61/548,455, filed on Oct. 18, 2011.
(60) Provisional application No. 61/577,977, filed on Dec. 20, 2011.
(60) Provisional application No. 61/635,441, filed on Apr. 19, 2012.
(60) Provisional application No. 61/668,662, filed on Jul. 6, 2012.

(51) Int. Cl. H01B 3/00; H01G 4/06

(52) U.S. Cl. 361/313; 174/137 B

(57) ABSTRACT

A method and apparatus for a capacitor comprises a first plate and a second plate. An insulator between the first plate and the second plate includes a first dielectric layer and a second dielectric layer. At least one interface between the first dielectric layer and the second dielectric layer includes one or more additives.

### RELATED CASES

This application claims the benefit of U.S. Provisional Application No. 61/505,862 filed on 8 Jul. 2011, U.S. Provisional Application No. 61/505,855 filed on 8 Jul. 2011, U.S. Provisional Application No. 61/505,842 filed on 8 Jul. 2011, U.S. Provisional Application No. 61/548,455 filed on 18 Oct. 2011, U.S. Provisional Application No. 61/577,977 filed on 20 Dec. 2011, U.S. Provisional Application No. 61/635,441 filed on 19 Apr. 2012, and U.S. Provisional Application No. 61/668,662 filed on 6 Jul. 2012, the contents of which are all incorporated by reference.

### TECHNICAL FIELD

This disclosure relates to insulators based upon one or more dielectric structures.

### BACKGROUND

Components, such as capacitors, may be used in any number of electronic devices. However, such components suffer from numerous disadvantages.

### SUMMARY OF DISCLOSURE

In one implementation, a capacitor comprises a first plate and a second plate. An insulator between the first plate and the second plate includes a first dielectric layer and a second dielectric layer. At least one interface between the first dielectric layer and the second dielectric layer includes one or more additives.

One or more of the following features may be included. The one or more additives may include at least one of calcium, tungsten, magnesium, aluminum, tin, zinc, and strontium. The one or more additives of the at least one interface may be configured to achieve a +2 valence state and may be further configured to form a non-directional O-M-O bonding pattern. The at least one interface may be a floating conductor layer. The at least one interface may be a deceleration layer. The deceleration layer may be effective within a range of kinetic energy between 5-50 eV. The at least one interface may be at least one of an electron stopper layer, a cascade quenching layer, a leakage path blocking layer, a kinetic energy absorbing layer, an avalanche dissipating layer, carrier recombination layer, a trapped/free charge lateral bleed-off layer, an electron-hole recombination zone, an ion accumulation layer, an electron accumulation layer and, a hole accumulation layer. The at least one interface may be at least one of a conductive layer, an insulating layer, a semiconducting layer, a semi-insulating layer, a metallic layer, a semi-metallic layer, and a non-dielectric layer. The at least one interface may increase the average dielectric constant of the capacitor insulator. The insulator may include a plurality of interfaces that may be aperiodic in spacing. A thickness of the at least one interface may range from 0.1 nm-10 nm. A spacing between one or more interfaces may range from 5 nm-500 nm. The insulator may have a thickness configured to operate at at least one of 100 volts, 1000 volts, 10 k volts, and 100 k volts. The at least one interface may further include, at least in part, one or more non-dielectric material layers. The at least one interface may further include, at least in part, an intermixing of the at least one additive with at least one of the first dielectric layer and the second dielectric layer. The intermixing may further include at least one of a chemical reaction, a resultant new material having chemical identity distinct from at least one of the first dielectric layer and the second dielectric layer, an interdiffusion, a resultant at least one concentration gradient, an interface transition zone/region, a resultant dielectric constant that is at least one of the same and different from that of at least one of the first dielectric layer and the second dielectric layer, one of a resultant electronic structure and set of electronic states distinct from that of at least one of the first dielectric layer and the second dielectric layer, and at least one of a resultant atomic vibration, phonon spectrum, and set of states different from that of at least one of the first dielectric layer and the second dielectric layer.

In another implementation, an apparatus includes an insulator. The insulator includes a first dielectric layer and a second dielectric layer. At least one interface between the first dielectric layer and the second dielectric layer includes one or more additives.

One or more of the following features may be included. The one or more additives may include at least one of calcium, tungsten, magnesium, aluminum, tin, zinc, and strontium. The one or more additives of the at least one interface may be configured to achieve a +2 valence state and may be further configured to form a non-directional O-M-O bonding pattern. The at least one interface may be a floating conductor layer. The at least one interface may be a deceleration layer. The deceleration layer may be effective within a range of kinetic energy between 5-50 eV. The at least one interface may be at least one of an electron stopper layer, a cascade quenching layer, a leakage path blocking layer, a kinetic energy absorbing layer, an avalanche dissipating layer, carrier recombination layer, a trapped/free charge lateral bleed-off layer, an electron-hole recombination zone, an ion accumulation layer, an electron accumulation layer, and a hole accumulation layer. The at least one interface may be at least one of a conductive layer, an insulating layer, a semiconducting layer, a semi-insulating layer, a metallic layer, a semi-metallic layer, and a non-dielectric layer. The at least one interface may increase the average dielectric constant of the capacitor insulator. The insulator may include a plurality of interfaces that may be aperiodic in spacing. A thickness of the at least one interface may range from 0.1 nm-10 nm. A spacing between one or more interfaces may range from 5 nm-500 nm. The insulator may have a thickness configured to operate at at least one of 100 volts, 1000 volts, 10 k volts, and 100 k volts. The at least one interface may further include, at least in part, one or more non-dielectric material layers. The at least one interface may further include, at least in part, an intermixing of the at least one additive with at least one of the first dielectric layer and the second dielectric layer. The intermixing may further include at least one of a chemical reaction, a resultant new material having chemical identity distinct from at least one of the first dielectric layer and the second dielectric layer, an interdiffusion, a resultant at least one concentration gradient, an interface transition zone/region, a resultant dielectric constant that is at least one of the same and different from that of at least one of the first dielectric layer and the second dielectric layer, one of a resultant electronic structure and set of electronic states distinct from that of at least one of the first dielectric layer and the second dielectric layer, and at least one of a resultant atomic vibration, phonon spectrum, and set of states different from that of at least one of the first dielectric layer and the second dielectric layer.

In another implementation, an apparatus includes an insulator. The insulator includes a first dielectric body. At least one interface of the first dielectric body includes one or more additives.

One or more of the following features may be included. The one or more additives may include at least one of calcium, tungsten, magnesium, aluminum, tin, zinc, and strontium. The one or more additives of the at least one interface may be configured to achieve a +2 valence state and may be further configured to form a non-directional O-M-O bonding pattern. The at least one interface may be a floating conductor layer. The at least one interface may be a deceleration layer. The deceleration layer may be effective within a range of kinetic energy between 5-50 eV. The at least one interface may be at least one of an electron stopper layer, a cascade quenching layer, a leakage path blocking layer, a kinetic energy absorbing layer, an avalanche dissipating layer, carrier recombination layer, a trapped/free charge lateral bleed-off layer, an electron-hole recombination zone, an ion accumulation layer, an electron accumulation layer, and a hole accumulation layer. The at least one interface may be at least one of a conductive layer, an insulating layer, a semiconducting layer, a semi-insulating layer, a metallic layer, a semi-metallic layer, and a non-dielectric layer. The at least one interface may increase the average dielectric constant of the capacitor insulator. The insulator may include a plurality of interfaces that may be aperiodic in spacing. A thickness of the at least one interface may range from 0.1 nm-10 nm. A spacing between one or more interfaces may range from 5 nm-500 nm. The insulator may have a thickness configured to operate at at least one of 100 volts, 1000 volts, 10 k volts, and 100 k volts. The at least one interface may further include, at least in part, one or more non-dielectric material layers. The at least one interface may further include, at least in part, an intermixing of the at least one additive with the first dielectric body. The intermixing may further include at least one of a chemical reaction, a resultant new material having chemical identity distinct from the first dielectric body, an interdiffusion, a resultant at least one concentration gradient, an interface transition zone/region, a resultant dielectric constant that is at least one of the same and different from that of the first dielectric body, one of a resultant electronic structure and set of electronic states distinct from that of the first dielectric body, and at least one of a resultant atomic vibration, phonon spectrum, and set of states different from that of the first dielectric body.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is an example qualitative depiction of the inverse relationship between insulator thickness and breakdown electric field;

FIG. 2 is an example schematic cross-section of layers within a small portion of an example insulator according to one or more embodiments of the disclosure;

FIG. 3 is an example multilayer capacitor architecture according to one or more embodiments of the disclosure;

FIG. 4 is an example conceptual drawing of a capacitor for derivation and analysis of electrostatics equations according to one or more embodiments of the disclosure;

FIG. 5 is an example plot of calculated electric fields in an insulator according to one or more embodiments of the disclosure;

FIG. 6 is an example plot of calculated electric fields in an insulator according to one or more embodiments of the disclosure;

FIG. 7 is an example plot of calculated electric fields in an insulator according to one or more embodiments of the disclosure;

FIG. 8 is an example plot of calculated electric fields, electric potential, electric displacement and effective dielectric constant in an insulator according to one or more embodiments of the disclosure;

FIG. 9 is an example plot of calculated electric fields, electric potential, electric displacement and effective dielectric constant in an insulator according to one or more embodiments of the disclosure;

FIG. 10 is an example apparatus for biased target sputter deposition (BTD) of capacitor layer materials according to one or more embodiments of the disclosure.

FIG. 11 is an example BTD apparatus according to one or more embodiments of the disclosure;

FIG. 12 is an example front view of the stencil mask of FIG. 11 according to one or more embodiments of the disclosure;

FIG. 13 depicts an example step-wise process according to one or more embodiments of the disclosure; and

FIG. 14 is example result of an example experiment and corresponding example calculation standard zeroth-order semi-classical electrostatics according to one or more embodiments of the disclosure.

Like reference symbols in the various drawings indicate like elements.

### DETAILED DESCRIPTION OF ONE OR MORE EMBODIMENTS

In one or more fields of electrically powered devices, e.g., autonomous electrically powered vehicles that may store their electrical energy on-board, the electrical energy storage technologies may include lithium ion batteries and so-called “ultracapacitors”. Ultracapacitors may not store even as much as, e.g., 10% of the energy density of lithium ion batteries, but they may be charged on a time-scale of, e.g., 1 minute versus, e.g., hours for lithium ion batteries, so may be workable to power vehicles such as buses which may make many predictable stops at which the capacitors may be charged. Besides being relatively faster to charge than batteries, capacitor use may generate less waste heat and may be more efficient overall, but may only provide vehicle ranges of, e.g., a few kilometers with modest amounts of stored energy, e.g., in at least one case <6 kilowatt hours ≈21 megajoules (MJ). It may be desirable to have capacitors that may store gigajoule (GJ) quantities of energy in a small enough form for, e.g., vehicles, since this may enable autonomous electrically powered vehicles having performance equal to ordinary cars, over-the-road trucks and railroad trains, for example, which may derive their power from liquid hydrocarbon fuels or distributed, continuously-contacted electrical networks. It also may be desirable if such GJ-class capacitors could be charged in, e.g., <1 second versus the tens of seconds typical for ultracapacitors.

In the quest for higher energy storage capability of capacitors, electrochemical double-layer capacitors, of which ultracapacitors may make up several variants, may be limited to only low voltages per plate-to-plate voltage difference, “low voltage” being defined with respect to typical electrochemical oxidation-and-reduction (“redox”) potentials of a few volts.

A physical (electrostatic) capacitor may include two charge carrying electrode plates separated by an electrical insulator. The stored energy and energy density (per unit volume of dielectric material within the capacitor) of a capacitor may be expressed as

$$\begin{matrix}{E}_{stored} = \frac{1}{2} {CV}^{2} & ( 1 \\ {E}_{d} = \frac{k {ɛ}_{0} {V}^{2}}{2 {d}^{2}} , & ( 2\end{matrix}$$

respectively, where C is the capacitance, k represents the dielectric constant (relative electric permittivity=1+the electric susceptibility) of the insulator, ε₀ is the permittivity of free space, V is the voltage between the electrode plates and d is the thickness of the insulator material. Thus, the energy density may be proportional to the voltage squared and to the dielectric constant, while it may be inversely proportional to the dielectric thickness squared.

In the field of physical capacitors, for example, increasing k, the dielectric constant of the capacitor insulator, may increase energy storage capabilities. k values of conventional capacitors may be relatively low, e.g., in the 2-10 range typical of resin-impregnated papers, polymer films and widely available ceramics such as silica and alumina-based compositions, to name just four types as examples. By contrast, specialty materials having k values of 10⁴ to 10⁶ and higher, which might be beneficial, e.g., for vehicle energy storage. However, these materials may exhibit one or more of several properties not helpful for energy storage capacitors, such as, e.g., charge leakage, material instability/inconsistency/non-homogeneity or low stand-off voltage. Most have been characterized only at low voltage.

The small-signal dielectric constant may be evaluated using, e.g., an Agilent HP 4284A LCR meter, which may impress a 2 volt RMSi signal (5.657 v peak-to-peak) across a 50 μm thick insulator sample, which may give an extremely low electric field value of ˜1×10-3 MV/cm. In such alternating current (AC) characterizations, the Maxwell-Wagner effect may be observed or suspected, which may mean that a significant portion of the observed capacitance is due to mobile charges at a macroscopic or mesoscopic scale, rather than being intrinsic to the material. This may be difficult to reproduce in all fabricated forms, may not be scalable and the free charges may be source of breakdown problems, and the static or direct current (DC) capacitance may be far smaller than indicated by the extremely large values of the AC dielectric constant. More generally, even for materials having lower k values in the range of, e.g., 20-1000, as the dielectric constant increases, the breakdown voltage may decrease. To compensate for the lower breakdown voltage, the insulator thickness d may be increased as k is increased. Examining Equation 2, this trend, which may be taken as linear in k and d over reasonable ranges, may nullify any advantage in capacitor energy density achievable via higher k materials.

Another way to achieve the desired high voltage stand-off in energy storage capacitors may be to increase the breakdown voltage, Ebd, of the capacitor insulator, which may allow V to be increased or d to be reduced in Equation 2. Increasing the breakdown voltage may be done by, e.g., a) using or fabricating more perfect forms of otherwise known, conventional insulator materials, b) laminating sheets of different types of insulators, and c) impregnating insulator materials with oils or resins, among possibly other approaches. Some methods and designs using such approaches and suited to mass manufacturing may achieve a breakdown electric field Ebd in excess of 1000 volts/mil 0.4 MV/cm. However, this may achieve only marginally higher Ebd values achievable at reasonable cost and confined to using materials with dielectric constant k values in the 3-5 range. In the field of, e.g., semiconductor microcircuits, for instance in complementary metal-oxide semiconductor (CMOS) transistor gate dielectrics and in memory cells involving micro-scale capacitors, ultra-thin (0.5-10 nm) insulating layers may exhibit significantly higher Ebd values than does the same material in bulk form and may exhibit Ebd values larger than 10 MV/cm. This effect may be observed, e.g., for low voltages, being broadly defined with respect to typical semiconductor junction potentials such as band shifts, “diode drops” and the like, that is, a few volts. Thus this enhanced E_{bd} effect may not be applicable to vehicle energy storage capacitors.

Superlattice single crystal dielectric structures may be used for insulators in, e.g., memory cells and similar circuits (e.g., Vcc by-pass capacitors) involving micro-scale capacitors. Crystalline superlattices may also be used to reduce leakage current and increase polarization (e.g., effective dielectric constant) over the expected properties of at least one of the materials alone, not in a superlattice. For example, use of BiFeO3/SrTiO3 crystalline superlattices with 11 nm period or wavelength, which may improve breakdown voltage and increase dielectric constant relative to a layer of BiFeO3 alone. Lattice mismatch strain may be caused by the superlattice which may induce the ferroelectric state in crystalline layers that may otherwise be paraelectric at a given temperature and vice versa, or may just shift the temperatures of such transitions. These effects may happen even with shorted plates (no applied field). However, Ebd>10 MV/cm may be reached with ultra-thin, mid-k (k=10-25) amorphous layers for transistor gate dielectrics. The k value may be much larger in order to have allowed enough thickness to make room for a superlattice. The enhancement in polarization in such cases may be due to predictable, strain-induced changes in cation location, distortions of O6 octahedra or the like, effects that may not happen regularly in, e.g., amorphous materials. The enhancement in polarization may occur in both materials in the superlattice. Nevertheless, ferroelectric superlattice capacitor insulators may be used for very-large-scale integration (VLSI) semiconductor circuits. Generally, known superlattice capacitor devices only operate at low voltages, as broadly defined above or at Vcc voltages of 3.2 v or <5 volts, and typically may not address high-k, high-Ebd and low leakage current in high voltage capacitors.

According to one or more embodiments, as will be discussed in greater detail below, one or more very thin dielectric layers may have an extremely high breakdown electric fields E_{bd}, as found, for example, in some transistor gate dielectrics. One or more of the ultra-thin layers may be repeated and distributed throughout, e.g., a capacitor insulator that may include mostly high dielectric constant (k) dielectric material and, according to one or more embodiments, a superlattice-like concept may be adapted to form a thick enough insulator slab with which to build high voltage capacitors, such as, e.g., 100, 1000, 10,000, 100,000 volts and higher.

According to one or more embodiments, as will be discussed in greater detail below, such thin high-E_{bd} layers may be interspersed and still enable large electric polarization of the high-k layers, in spite of the low-k typically exhibited by such high-E_{bd} layers, to form essentially one solid slab of high dielectric constant material throughout the thickness of a high voltage insulator (e.g., capacitor insulator) and may have effective dielectric constants of, e.g., 25, 50, 200 and higher.

According to one or more embodiments, as will be discussed in greater detail below, the thin high-E_{bd} layers may be adapted as interfaces between thicker dielectric layers, and the interfaces may have one or more functions contributing to increasing breakdown field, reducing leakage current and/or increasing an effective k value, all for the capacitor insulator as a whole.

According to one or more embodiments, as will be discussed in greater detail below, the thickness, spacing and/or pitch of various layers in the capacitor insulator may be aperiodic rather than perfectly periodic or regular. Thus, according to one or more embodiments, capacitors may simultaneously have high dielectric constant and high voltage stand-off, thereby providing a large amount of stored charge at high potential difference, which may give beneficially large amounts of stored energy.

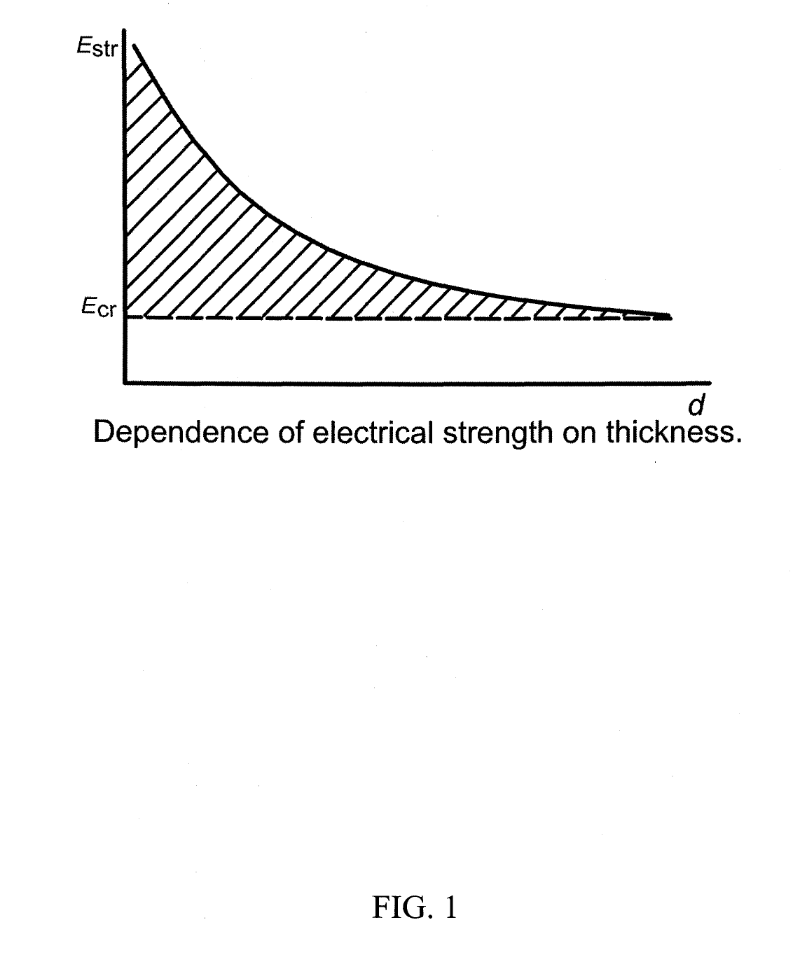

As discussed above and referring also to FIGS. 1-14, a capacitor may comprise a first plate (e.g., plate 220) and a second plate (e.g., plate 240). An insulator (e.g., capacitor insulator 100) between the plate 220 and plate 240 may include a first dielectric layer/body (e.g., dielectric layer 120) and an optional second dielectric layer. At least one interface (e.g., interface 110) between dielectric layer 120 and the second dielectric layer may include one or more additives.

For example, according to one or more embodiments, an insulator (e.g., capacitor insulator) may include, for example, at least a dielectric-dielectric interface that includes one or more additives. Capacitor insulators may be characterized by at least a dielectric constant, k, and a breakdown electric field, E_{bd}, also called a dielectric strength, Eₛₜᵣ. For energy storage capacitors, it may be necessary that the capacitor insulator exhibit low leakage current at applied fields below the breakdown electric field, E_{bd}. Energy storage may broadly be described as storage on a time-scale of at least seconds, minutes, hours, days or longer. Therefore, the frequency-dependent properties of a capacitor insulator that are in the low-frequency range (ω<<1 s) or so-called direct-current (DC) may be important.

According to one or more embodiments, supporting a large, static, stored energy density across a thin capacitor insulator may require a high-k material with a high breakdown voltage and low charge leakage at high voltages over sustained periods of time (>>1 s). In high voltage capacitors, for example, low charge leakage may be synonymous or redundant with high-E_{bd} in at least one mechanism of breakdown involving electron-impact ionization. That is, electrons free enough to migrate or cause leakage may also cause breakdown.

According to one or more embodiments, very thin dielectric layers may seem to have a higher breakdown electric field than thicker specimens of the same material and this effect may be adapted to or create a structure that may have this effect for thicker dielectrics, which may then be used as one or more capacitor insulators in high voltage capacitors. According to one Or more embodiments, “high voltage” may broadly be defined as ten or more times the few volts typified by electrochemical redox potentials and semiconductor junction potentials, as broadly defined above to be “low voltage”. A summary of this effect is shown in FIG. 1, which may show qualitatively this inverse relationship between E_{bd} and thickness. The effect may occur in thicknesses <1000 nm for, e.g., alkali halide salt single crystals. This effect may be explained by noting that in thinner dielectrics, free electrons may not have enough acceleration length under the influence of an external electric field to achieve speeds sufficient to cause electron-impact ionization of atoms, ions or molecular moieties in the host dielectric lattice, which may then lead to avalanche or electron cascade breakdown. Generally, the threshold kinetic energy for electrons to cause electron impact ionization of most materials may be 3 to 18 electron volts (eV), which may include electron speeds of 1 to 2.5×10⁶ meters/s, respectively. While the exact microscopic (atomic-scale) mechanisms may be different, they may depend upon the materials involved and may be partially unknown, this effect has typically been assigned to phenomena occurring in pure electric-field-induced breakdown, not in electrothermal or electrochemical breakdown; thus it may be relevant to high voltage energy storage capacitors operating within, e.g., ˜100° C. of room temperature. Further confirmation and quantification of the same effect, or at least a similar effect, has been achieved with, for example, gate insulators for transistor structures. For example, E_{bd} of amorphous aluminum oxide films of, e.g., 1.2 to 6.0 nm thickness consistent with classical models may be valid to less than 30 nm thickness. There may be a dramatic increase in E_{bd} for films with thickness, e.g., <˜4 nm. At room temperature, measured E_{bd} values may be, e.g., ˜10 MV/cm for ≧4 nm but ˜18 MV/cm for 2.5 nm and ˜30 MV/cm for 1.2 nm thicknesses. There may be numerous possible microscopic physical mechanisms at play and various assumptions in mathematical models that may give rise to or allow interpretation of the data as the high E_{bd} values reported. However, the leakage current density at these high fields for 1 to 2 nm thickness films may range on the order of 1 to 10 A/cm² for transistor gate insulators, which may be excessive for energy storage applications by several orders of magnitude.

According to one or more embodiments, ultra-thin layers such as those noted above exposed to electric fields on the order of, e.g., 10 MV/cm may exhibit non-linear polarization and become more polarized than a linear extrapolation from lower fields may suggest, i.e., that their dielectric constant may increase beyond the value associated with the bulk material (which may not be exposed to such high fields without breaking down). According to one or more embodiments, an amorphous material for the ultra-thin layer may be used.

According to one or more embodiments, a thin film deposition technique may be used for growing amorphous aluminum oxide films of thickness that enable the use of very thin amorphous dielectric and other types of layers to achieve high breakdown electric field for the capacitor insulator as a whole.

According to one or more embodiments, an insulator (e.g., capacitor insulator) of sufficient thickness to stand off high voltages, such as 100 v, 500 v, 1,000 v, 10,000 v, 100,000 v and higher, may be realized in an insulator that may include but is not limited to a first dielectric layer (or dielectric body), a second dielectric layer and at least one interface between the first dielectric layer and the second dielectric layer. The at least one interface between the first dielectric layer and the second dielectric layer may include one or more additives.

For example, according to one or more embodiments, a plurality of first dielectric layers, second dielectric layers and interfaces may include additives disposed between them may be formed in an insulator of sufficient thickness for operation at least at the above noted voltages.

According to one or more embodiments, the first dielectric layer and second dielectric layer may include the same type of material or different types of material. According to one or more embodiments, a second, third, fourth and so forth type of dielectric material may include the first dielectric layer and second dielectric layer. According to one or more embodiments, only selected interfaces between the first dielectric layer and second dielectric layer include the one or more additives, wherein those interfaces that may not include one or more additives may be similar to dielectric-dielectric interfaces well known in the field.

According to one or more embodiments, the selection of interfaces formed with the additives may result in a spacing of additive-bearing interfaces that may be aperiodic (e.g., in distance and/or in momentum space) as estimated for electrons moving within a certain velocity range. According to one or more embodiments, a thickness of first dielectric layer and/or a thickness of second dielectric layer may be varied to result in a spacing of additive-bearing interfaces that is aperiodic (e.g., in distance). As used herein, the term “aperiodic” may be broadly interpreted as, for example, a) not equally spaced, b) random or pseudo-random in spacing and/or c) irregular in spacing, as will be discussed in greater detail below.

According to one or more embodiments, additives for one or more interfaces may include but are not limited to, added materials, atoms, molecules, chemical elements, substances, layers and the like that may include, for example, Be, B, C, N, O, Mg, Al, Si, P, S, Ca, Sc, Ti, V, Cr, Mn, Fe, Co, Ni, Cu, Zn, Ga, Ge, As, Se, Sr, Y, Zr, Nb, Mo, Ru, Rh, Pd, Ag, Cd, In, Sn, Sb, Te, Ba, Hf, Ta, W, Re, Os, Ir, Pt, Au, Hg, Tl, Pb, Bi, Po, La, Ce, Pr, Nd, Pm, Sm, Eu, Gd, Tb, Dy, Ho, Er, Tm, Yb, Lu, compounds of these, reaction products of these and inter-reaction products of these (or combinations thereof) with a constituent of first dielectric layer and/or second dielectric layer. According to one or more embodiments, a chemical precursor or alternate physical form that includes one or more of the additives may be used. For example, oxygen may be added in the physical form of steam, to deliver chemical precursor H₂O, which may then lose H to add substantially pure O to an interface. As another example, Ti may be added in the physical form of Ti⁺, Ti⁺⁺, Ti⁺⁺⁺ and so forth gaseous ions using an ion implanter, where Ti ions may become neutralized, penetrate a distance into first dielectric layer or body, then come to rest forming a Ti-additive region (e.g., buried interface) within the first dielectric or, as may be appropriate, creating a first dielectric layer beneath the ion-implanted zone, the Ti-containing interface and a second dielectric layer through which the mobile Ti may pass to reach and form the interface.

According to one or more embodiments, to form a thickness of capacitor insulator configured to stand off operating voltages of 100 v, 500 v, 1,000 v, 10,000 v, 100,000 v and higher, the interface and its adjacent first and/or second dielectric layer(s) may be further combined with other dielectric layers and additive-bearing interfaces, where the additive-bearing interfaces may be the same or different from each other and any still further additive-bearing interfaces may include the capacitor insulator.

According to one or more embodiments, an interface may include additives that may be thick enough to be atomically, molecularly or chemically compositionally distinct from its adjacent first and/or second dielectric layer(s). The additive-bearing interface may be a “layer”. According to one or more embodiments, the thickness may be at least one atomic diameter, such as 0.3 nm, but may be much larger, such as 3 to 30 nm or more, in cases where, for example, intermixing or diffusion of interface additive atoms and atoms of first and/or second dielectric layer(s) occurs. Such intermixing and diffusion may occur with or without chemical reactions of the intermixing or inter-diffusing species. A chemical or atom concentration gradient may be used over distance, e.g., distance along a direction of the operationally-applied or prevailing electric field.

According to one or more embodiments, the intermixed region and/or a zone of the concentration gradient may entirely “consume” or involve the at least one additive, where the interface may be the last region or zone. For example, the interface may include one or more additives that may not be a “layer” in the sense of having a distinct chemical identity, distinct from first and/or second dielectric layer(s). According to one or more embodiments, an interface may include one or more additives thick enough (and/or not intermixed enough) such that the interface may be a distinct “layer”. However, there may still exist an intermixed region with first dielectric layer on one side of the layer and/or an intermixed region with second dielectric layer on the other side of the layer. According to one or more embodiments, a compound interface or a complex interface structure may exist. Therefore, recognizing the aforesaid variations in intended meaning, the term “layer” may be used where appropriate to signify the interface that includes one or more additives. According to one or more embodiments, an interface that may include one or more additives may be represented where appropriate in the figures and drawings as, for example, a simple graphic indicating a layer much like any other layer. For example, reference numeral “110” may designate the interface that includes one or more additives.

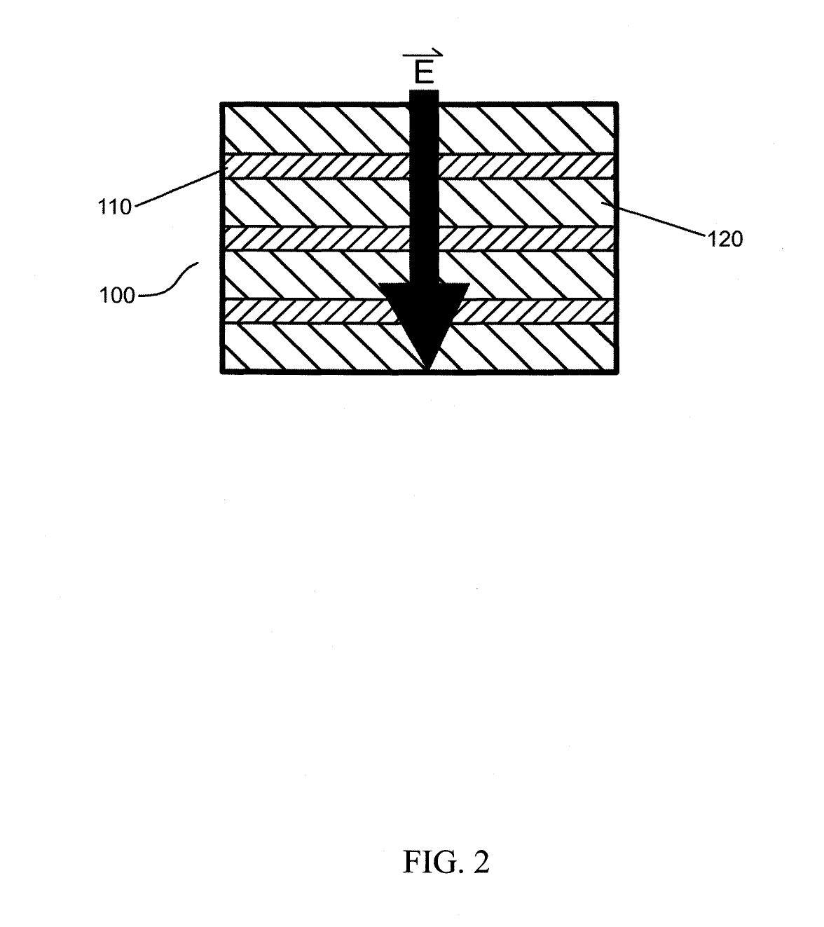

According to one or more embodiments, FIG. 2 illustrates an example insulator (e.g., capacitor insulator 100), viewed from the edge, that is, with planar layers of capacitor insulator 100 extending perpendicular to the plane of the page. A layer (e.g., layer 110) may represent at least one interface between a first dielectric layer and a second dielectric layer that may include one or more additives, which may be ultra-thin, (e.g., 0.5 to 5 nm or 0.1 to 10 nm in thickness), up and down in the plane of FIG. 2. One or more layers (e.g., layer(s) 120) may represent a first dielectric material, which may have thicknesses, for example, such as 2 to 200 nm, up and down in the plane of FIG. 2. However, those skilled in the art will recognize that other thicknesses may be appropriate.

According to one or more embodiments, a repeating unit of capacitor insulator 100 may include at least one dielectric layer 120 and at least one interface (e.g., interface 110). Dielectric layer 120 may at times be referred to as a high-k dielectric or as a main dielectric (layer), since capacitor insulator 100 as a whole may have high dielectric constant k and since capacitor insulator 100 may dominantly include one or more layers and materials of first dielectric layer 120.

According to one or more embodiments, capacitor insulator 100 may be asymmetric, that is, having non-equal thicknesses of dielectric layers 120 and one or more interfaces 110 in the repeating unit. According to one or more embodiments, a total thickness of interface additive, summed throughout the capacitor insulator, may range from, e.g., 1% to 20% of the thickness of capacitor insulator 100. However, symmetric repeating units may fall within the scope of the disclosure.

According to one or more embodiments, those skilled in the art will appreciated that while only one each of dielectric layers 120 and interfaces 110 are depicted, to provide the functions of high-E_{bd}, low leakage current and high-k for capacitor insulator 100, additional dielectric layers, second dielectric layers and interfaces with at least one interface that may include one or more additives may be used within each repeating unit. According to one or more embodiments, an additional function of relieving build-up of lateral film stress, may be accomplished with additional layers in capacitor insulator 100. Generally, these stress-relieving layers may or may not be included in every repeating unit of capacitor insulator 100 but may reside in special, more sparsely placed layers and/or may be incorporated in special dielectric material layers.

According to one or more embodiments, capacitor interfaces may be placed within capacitor insulator 100 which may have an electrical function, as opposed to more mechanical functions such as stress relief mentioned above, and may also have spacings from one another, such as, for example, 20 nm to 100 nm or 5 nm to 500 nm, on average. According to one or more embodiments, these spacings may relate to each interface's intended electrical function and how adjacent or near-adjacent interfaces work together. Various embodiments described herein elucidate one or more interface structures, functions and spacing according to one or more embodiments.

According to one or more embodiments, although the materials of 110 and 120 may be described as “dielectric” materials, at least one or more interfaces that may include one or more additives 110 and any additional layers such as stress-relieving layers may be, e.g., metallic, semi-insulating, semiconducting, conducting or semi- metallic (for example, allotropes or metastable forms of carbon) rather than being commonly known insulator materials. The terms “non-dielectric”, “non-dielectric material”, “non-dielectric layer” and similar may be used to refer to, e.g., the last-mentioned list, even though many materials may possess at least some dielectric properties, such as an optical dielectric function. According to one or more embodiments, there may be many physical functions or properties making up the high breakdown material function within a capacitor insulator structure of one or more embodiments of the disclosure, which may include, for example, deceleration of electrons moving under the influence of the prevailing electric field, de-excitation or energy dissipation (for example, of excitons and hopping electrons, among others), trapping and/or draining away free or mobile charges, recombining electron holes with electrons and so forth. Likewise, according to one or more embodiments, there may be many physical functions or properties making up a low-leakage current function and a high-k function within a capacitor insulator structure of the disclosure.

According to one or more embodiments, non-dielectric materials may be used for these and similar functions in some insulator structures. While four repeating units of capacitor insulator 100 are shown in FIG. 2, those skilled in the art will recognize that an insulator used for high voltage (as broadly defined above) capacitors may include hundreds, thousands or more of such repeating units. As such, the exact number of repeating units shown should be taken as an example only and not to limit the scope of the disclosure.

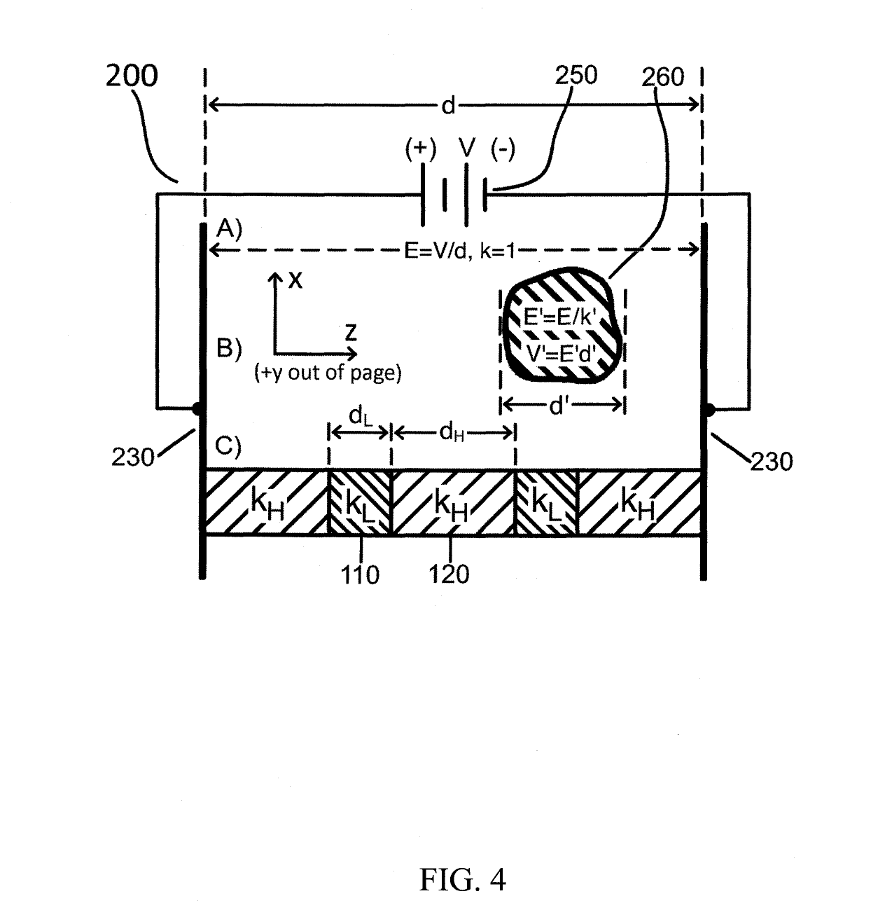

According to one or more embodiments, and as depicted in at least FIG. 4 case C, is an example design in which capacitor insulator 100 is terminated with an extra half repeating unit that may include one of a first dielectric layer and/or a second dielectric layer, so that when capacitor insulator 100 is built into a capacitor, a dielectric layer may be adjacent to each capacitor electrode plate. According to one or more embodiments, for example, with vacuum-based thin film deposition, special layers may be added at or adjacent to the plates, for such purposes as, e.g., adhesion-promoting, diffusion blocking, chemical compatibility, planarization, stress relief, atomic structure stabilization, bridging of grain boundaries, uniformizing lateral distribution of free charge density and other functions, without departing from the scope of the disclosure. For example, it may be beneficial to include an interfacial ferroelectric layer, which may permanently maintain polarization as if the capacitor were fully charged or is very easily polarizable, to, for example, avoid a polarization-dead-layer for, e.g., ultra-thin capacitor applications.

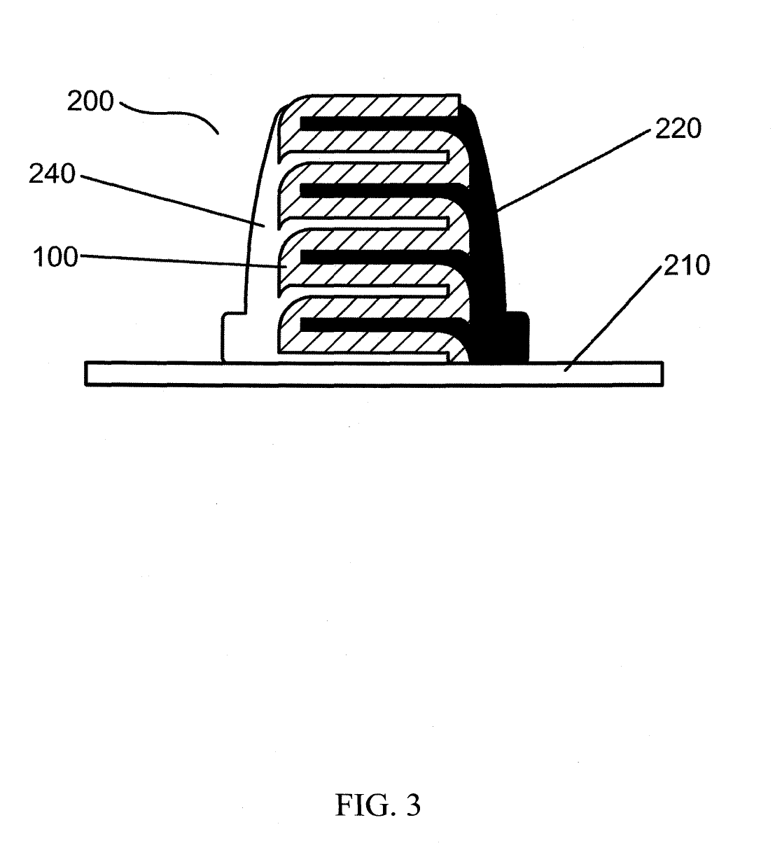

According to one or more embodiments, and referring at least to FIG. 3, an example capacitor architecture 200 is shown as a cross-sectional cut through the capacitor. According to one or more embodiments, a flat substrate 210 for the capacitor may be useful and is depicted, however, flat substrate 210 may be removed after completion of the capacitor device. According to one or more embodiments, alternating metal or other conductor materials 220 and 240 may form both the active capacitor plate or electrode areas of the capacitor and attachment terminals of the capacitor to an external circuit. Plates 220 and 240 may be interleaved and separated by layers of capacitor insulator 100, which may be substantially the same as structure 100 in FIG. 2. This interleaved stacking geometry may provide many parallel capacitors stacked together in a self forming design. This layering technique may pack a large charge carrying surface area into a small volume. The geometry may be highly flexible: e.g., scaling in length, width and depth. The solid state stacked design may produce fast discharge rates due to the short distances between the plates and the connecting plate tabs. Thus, with a high-k capacitor insulator as described in one or more embodiments, this capacitor architecture may store high energy density while providing fast charge and discharge times.

According to one or more embodiments, capacitor insulator 100 may be subjected to an electric field 130 when used within a capacitor, which may be due to charges placed onto plates above and below the repeating units of the insulator material shown. Thus E field 130 may be substantially normal to the plane of the repeating units and parallel to the layer stacking direction. According to one or more embodiments, the manner in which voltage, fields, charges and polarizations distribute themselves in a capacitor filled with a linear dielectric material may be solvable for “simple” geometries using, e.g., Gauss' Law in integral form, which may be called a “semi-classical” representation. However, a capacitor with an insulator that may be composed of a stack of dielectric materials with different dielectric constants may not be a simple geometry. According to one or more embodiments, since capacitance C=ε₀kA/d, where ε₀ is the permittivity of vacuum, k is the average dielectric constant of the capacitor insulator, A is an area of the capacitor plates and d is the plate spacing, is proportional to permittivity ε=ε₀k, the method of calculating a series capacitance may also hold for calculating a series permittivity. That is, Cₜₒₜₐₗ⁻¹=C₁⁻¹+C₂⁻¹+C₃⁻¹+ . . . implies that εₜₒₜₐₗ⁻¹=ε₁⁻¹+ε₂⁻¹+ε₃⁻¹+ . . . for the effective permittivity of a stacked dielectric. In other words, the permittivity of the stack may be less than or equal to the permittivity of the layer with the lowest permittivity. However, according to one or more embodiments, this may not be the case.

For example, according to one or more embodiments, a solution may be constructed beginning from the voltage impressed upon the plates of the capacitor, since this voltage may be fixed using a low-impedance power supply or battery. Such a situation is shown in FIG. 4, where hypothetical capacitor 200 with infinite parallel plates 230 spaced a distance d apart have a voltage V applied across them by battery 250. Three example cases, A, B and C, are depicted in one capacitor 200, for convenience.

In FIG. 4 case A, only a vacuum may exist between the plates, and the vacuum may have a dielectric constant of k=1. A uniform electric field E may exist in the z-direction at any place between the plates and has magnitude equal to V divided by d, that is |E|=E=V/d. FIG. 4 case B shows a finite-sized object 260, having larger molecular dimensions, placed between the plates of the capacitor but otherwise only a vacuum may be between the plates. If, for example, object 260 has roughly width d′ and is made of a linear dielectric material having dielectric constant k′, electric susceptibility χₑ′=k′-1 and permittivity ε′=εᵣ′·ε₀=(1+χₑ′)·ε₀, where the relative permittivity εᵣ′ is unitless and has the same value as the dielectric constant, the semi-classical one-dimensional electrostatics theory may teach that the electric field inside the piece of dielectric material 260 may be

E′≈E/εᵣ′=E/k′

in the z direction. The exact value may depend upon undefined geometrical considerations, for instance accounting for how many lines of electric flux may go through object 260 due to its enhanced permittivity that may otherwise have passed around it. The field inside the dielectric may be reduced by a factor of ˜k′=εᵣ′ due to the polarization of the material partially canceling the applied field. Polarizing the dielectric object 260 may require energy, and battery 250 may pump a charge to plates 230 against a preexisting voltage to raise and keep the voltage constant at V volts, thus work may be performed and energy may be extracted from the battery. According to one or more embodiments, if object 260 has an irregular shape, a potential difference V′≈E′·d′ may exist across object 260 in the direction z of the applied E field.

According to one or more embodiments, and referring at least to FIG. 4 case C, the space between electrode plates 230 of capacitor 200 may be completely and tightly filled with dielectric material. For example, two types of dielectric material are shown, one with a higher dielectric constant k_{H} and one with a lower dielectric constant k_{L}, both of which may be known. For example, three thicker slabs 120 of thickness d_{H} and two thinner slabs 110 of thickness d_{L} are shown for the high and low dielectric constant materials, respectively. The relative layer thicknesses and/or relative values of dielectric constant may be interchanged without affecting this derivation or any uses of it.

According to one or more embodiments, an interface between a first dielectric layer and a second dielectric layer, the interface itself may possess a distinct dielectric constant, which may be taken as k_{H}, k_{L} or a third value kᵢ as the derivation is generalized below to three, four or more distinct dielectric constants. Likewise, the last mentioned interface may be thought of as a layer, itself, for purposes of this derivation and for describing one or more embodiments of the disclosure, as the derivation may be generalized below to any number of layers. The voltage between the capacitor plates is still V, so the electric potential across each of the dielectric slabs, V_{layer}=E_{layer}·d_{layer}, may sum up to V. For example, for FIG. 4 case C, V=Σ(Eᵢ·dᵢ)=E_{H}·d_{H}+E_{L}·d_{L}+E_{H}·d_{H}+E_{L}·d_{L}+E_{H}·d_{H}, for i=H and L, where 3·d_{H}+2·d_{L}=d.

Implicit in the equation may be the assumption that the electric potential is the same on both sides of each dielectric-dielectric interface, else the sum in the equation may be undefined. This may be a boundary condition, imposed by the analyst, and may be a compound boundary condition, applied once for each interface and to the electric potential function on both sides of each interface. While this may be a reasonable assumption or imposition of boundary conditions, the more general impact upon the electric potential may be given by Poisson's equation:

∇²V(r)=−ρ_{v,free}(r)/ε, which in the present 1-D geometry is ∇²V_{z}(z)=−ρ_{v,free}(z)/ε,

where ρ_{v,free} is the so-called “free charge” with dimensions of charge per unit volume and units of C/m³. If free charge existed anywhere in the dielectric stack of FIG. 4 case C, particularly at the dielectric-dielectric interfaces, then the equation may be lacking necessary terms. Also assumed in the equation is that electric fields E_{H} and E_{L} are constant or uniform through the thickness of their respective dielectric slabs, which may be a convenient assumption in semi-classical electrostatic theory, likely to be valid when d_{H} and d_{L} are much thicker than the transitional boundary or interface between the slabs. According to one or more embodiments, however, d_{L} may represent the thickness of interface 110 and may be on the order of molecular dimensions or only ten times that order, so both d_{H} and d_{L} may not be much thicker than the transitional boundary or interface between the slabs. At least in that case, the discrete sum equation for V may be replaced with

V=∫_{z=0}^{d}E(z)dz

where z=0 may be defined at the left plate of capacitor 200 of FIG. 4, as drawn, and d may be as given above. The equation immediately above may allow E(z) to assume continuously varying values along the z-direction through the stack of dielectric slabs, which may allow for electric field gradients at and near interfaces between the slabs as well as throughout the thickness of any slabs, as may occur in reality, such that the integral yields the necessary value V of the applied voltage. The computation or estimation of E(z) may be complicated for structures explicitly involving important physics and chemistry at molecular dimensions.

According to one or more embodiments, the interface between a metallic capacitor plate (e.g., electrode) and an adjacent dielectric material may be more complex. For example, phenomenological models of a metal-dielectric interface which may only consider a ‘series capacitor model’ and the penetration of the electric field into the plate in a semi-classical manner may be inadequate. Instead, a first-principles treatment, using for example, density functional theory, capable of representing or approximating a quantum mechanical description of the materials at the atomic level, may be required to unravel the charge densities, electric fields and polarizations at such interfaces.

According to one or more embodiments, a semi-classical treatment of the dielectric stack in capacitor 200 of FIG. 4 case C is shown. A “Zeroth-Order” approximation to the internal fields in the dielectric stack as a function of various layer thicknesses may be presented first. The gross or average field between capacitor plates 230 may be E_{avg}=V/d, ignoring penetration of fields into plates. The zeroth-order approximation may be

E_{H}≈E_{avg}/k_{H}=E_{avg}/ε_{r,H} and E_{L}≈E_{avg}/k_{L}=E_{avg}/ε_{r,L},

which may assume that the local value of the externally-applied polarization-driving field at each dielectric layer may be approximated by E_{avg}. The equation also may assume that electric fields E_{H} and E_{L} are constant or uniform through the thickness of their respective dielectric slabs. A slightly better zeroth-order approximation is made agnostic about the unknown polarizing fields by taking the ratio of the above two equations,

E_{H}/E_{L}=k_{L}/k_{H}=ε_{r,L}/ε_{r,H}=ε_{L}/ε_{H},

and indicates that the fields in the two dielectrics may be inversely proportional to their permittivity. This zeroth-order approximation may be related to an alternate set of possible boundary conditions,

D_{⊥, H}=D_{⊥, L} or Z_{z}(z)_{H}=D_{z}(z)_{L}

at each dielectric-dielectric interface, where D is the electric displacement vector or the electric flux density vector, and only the component of this vector normal to the plane of the interface may be constrained by the boundary condition. Under the assumption of uniform electric fields throughout the thickness of all dielectric slabs, the equivalence between the above equations may be seen from the standard definitions valid inside a dielectric material:

D=ε₀·E+P [units C/m²]

P=ε₀·χₑ·E [units C/m²]

k=ε_{r,}=1+χₑ=ε/ε₀, [unitless]

where the symbols are defined above except P is the polarization density within the dielectric material, having dimensions of dipole moment per unit volume and units of [C·m/m³]=[C/m²]. Substituting one of the equations into the other and collecting terms using another equation allows

D=ε₀·(1+χₑ)·E=ε₀·εᵣ·E=ε·E=ε₀·k·E.

Then the boundary condition equality D_{z}(z)_{H}=D_{z}(z)_{L} may be expressed, for the vector components normal the planes of the stacked dielectric layers, as:

ε₀·k_{H}·E_{H}=ε₀·k_{L}·E_{L},

which may reduce exactly to E_{H}/E_{L}=k_{L}/k_{H}, the zeroth-order approximation herein. A possible byproduct of all these assumptions is that D may not only be continuous across every dielectric-dielectric interface, D may be absolutely constant through the whole capacitor insulator, from one plate to the other plate. This result may be consistent with an understanding that there may be no free charges interior to an insulator, which means that Poisson's equation may reduce to LaPlace's equation, which may be one of the above equations with the right hand side set to zero. The equation is equivalent to ∇·D=ρ_{v,free}=0 for the case of constant D throughout an insulator.

According to one or more embodiments, the effect of layer thicknesses on field magnitudes may be seen by rearranging one of the equations into E_{L}=E_{H}·(k_{H}/k_{L}), substituting this into the discrete sum equation for V above and solving for E_{H}:

E_{H}=V·[n_{H}·d_{H}+n_{L}·d_{L}·(k_{H}/k_{L})]⁻¹,

where n_{H}=3 and n_{L}=2 for the number of high-k and low-k layers, respectively shown in FIG. 4. Taking E_{H}=E_{L}·(k_{L}/k_{H}), substituting this into the discrete sum equation for V above and solving for E_{L} gives:

E_{L}=V·[n_{H}·d_{H}·(k_{L}/k_{H})+n_{L}·d_{L}]⁻¹.

According to one or more embodiments, in this zeroth-order semi-classical model for the E-fields within the dielectrics, the ordering, the relative number and the proximity of high-k and low-k layers to each other may not matter. By purely algebraic considerations, even the thickness of the individual high-k and low-k layers may make no difference; only the total thickness of high-k material and the total thickness of low-k material may matter. Therefore, not all high-k layers must be of d_{H} thickness and not all low-k layers must be of d_{L} thickness; each d_{H,i} for i=1 to n_{H} and each d_{L,j} for j=1 to n_{L}may have different thickness. It follows that some of the equations may be generalized with inverse-permittivity-weighted lump-sum distances from the high-k and low-k material thicknesses:

E_{H}=V·[Σd_{H,i}+(ε_{H}/ε_{L})·Σd_{L,j}]⁻¹ and

E_{L}=V·[(ε_{L}/ε_{H})·Σd_{H,i}+Σd_{L,j}]⁻¹,

where the sums run over i=1 to n_{H} and j=1 to n_{L}. The permittivities have been used per k=ε_{r,}=1+χₑ=ε/ε₀ above.

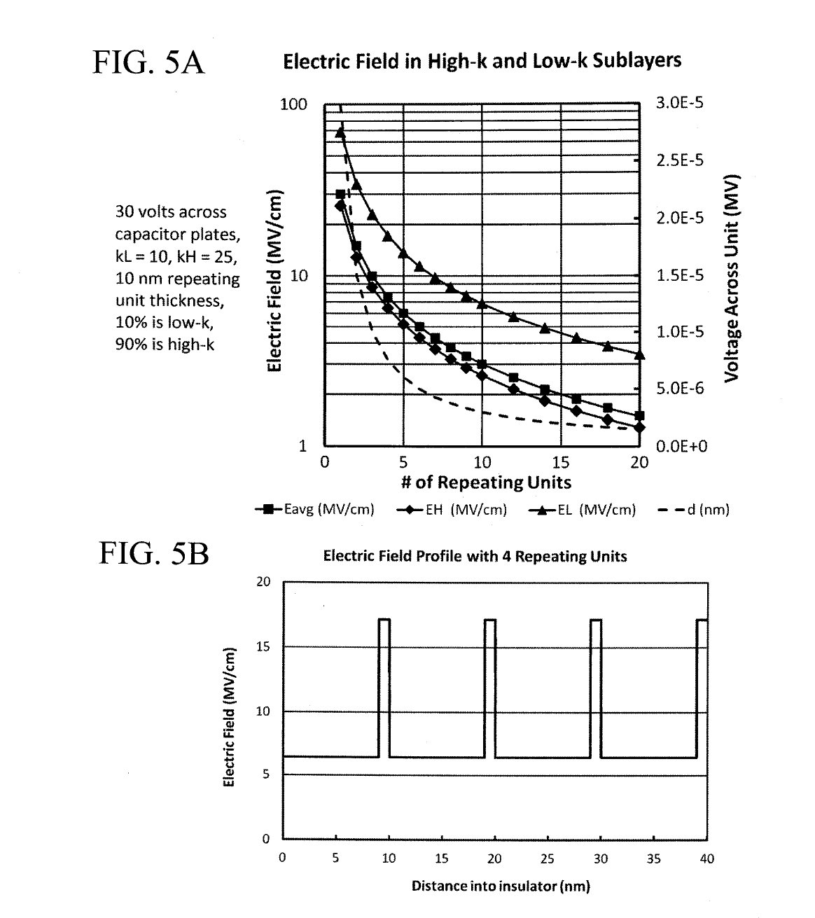

Notwithstanding the algebraic lumping of layer thicknesses in the zeroth-order approximation, the variation of E_{H} and E_{L} with layer thickness may be instructive and is plotted in FIGS. 5-7 for values of V, k_{H}, k_{L}, d_{H}, d_{L}, n_{H} and n_{L} relevant to one or more embodiments of the disclosure. For example, in FIG. 5A (upper panel) it is shown the result of a zeroth-order semi-classical model calculation for a capacitor with V=30 volts, k_{H}32 25, k_{L}=10, d_{H}=9 nm and d_{L}=1 nm. n_{H}=n_{L} are varied from 1 to 20 as the abscissa. The voltage appearing across each repeating unit (one each of a high-k and low-k layer) is plotted in megavolts (MV) on the right axis, and it decreases from 3×10⁻⁵ to 1.5×10⁻⁶ MV=30 volts to 1.5 volts as more repeating units are added between the plates of the capacitor. The average field E_{avg} [MV/cm] in each repeating unit is simply this voltage divided by 10 nm expressed in centimeters. The “partitioning” of the electric field needed so that some of the equations yield the required V=30 volts is calculated using the last equations for E_{H} and E_{L} above. The lower-k material 110 may polarize less and bucks the impressed field less than the higher-k material 120, so its E_{L} may always be higher than E_{H}. The ratio E_{L}/E_{H} may always be exactly 2.5, the ratio of the permittivities or dielectric constants, as enforced by the above E_{H}/E_{L}=k_{L}/k_{H} approximation. An example of field and surface charge density values for a specific number of insulator repeating units are given in Table 1.

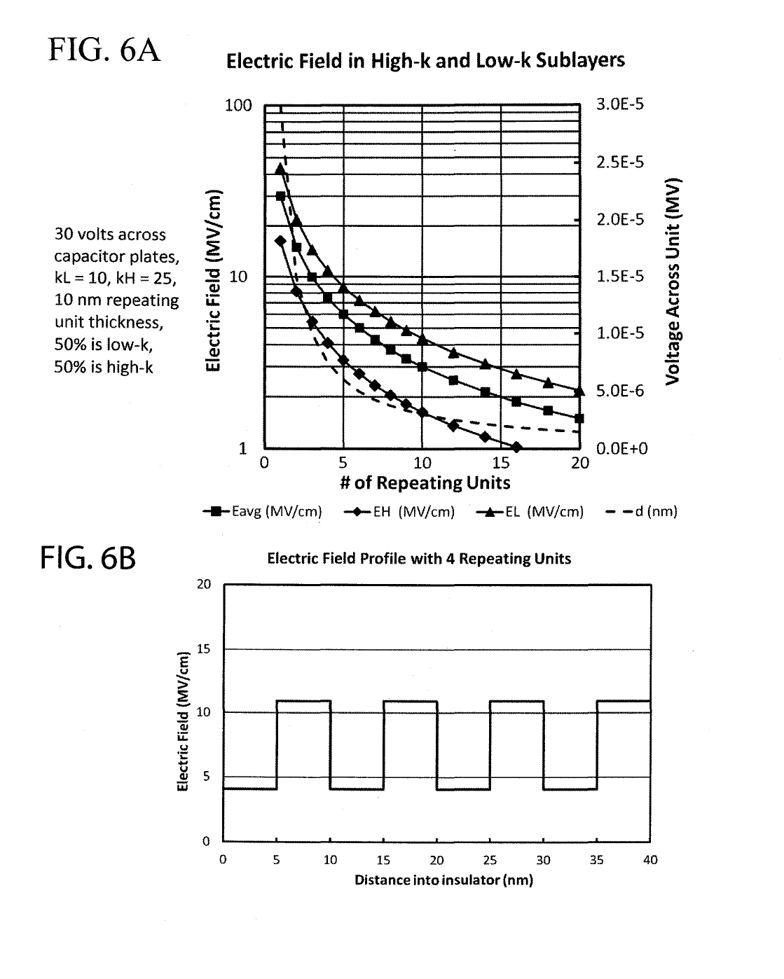

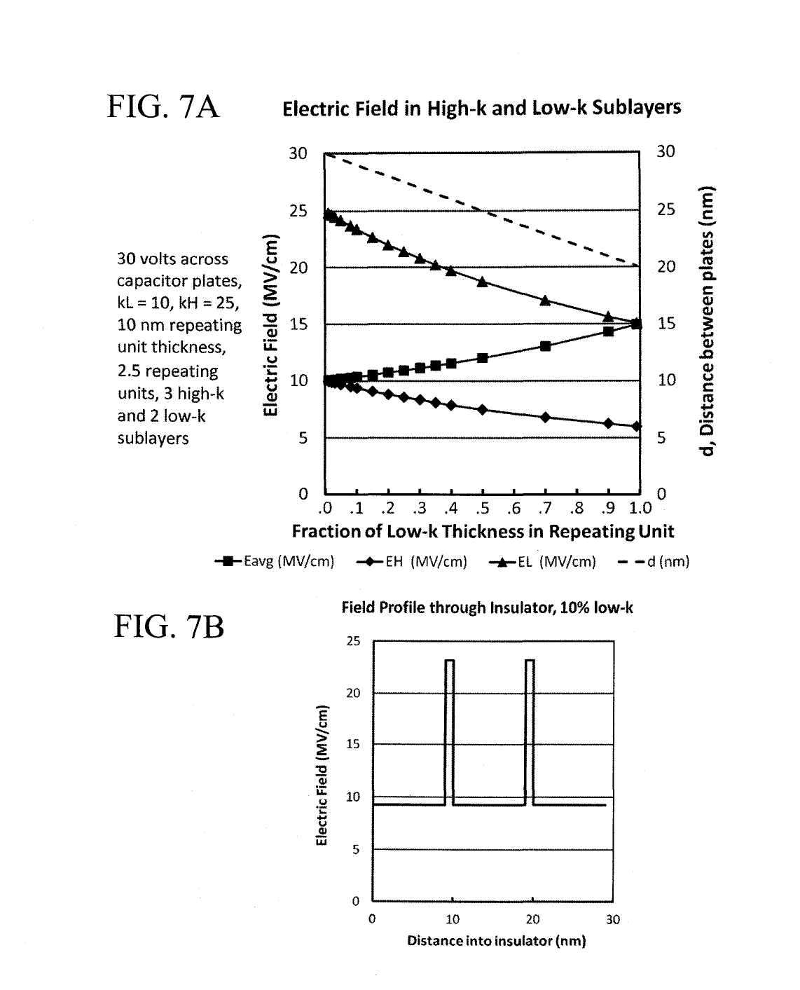

According to one or more embodiments, and referring at least to FIGS. 6A and 7A, it is shown two more sets of calculated zeroth-order results for different combinations of dielectric layers and their thicknesses, with all other parameters remaining the same as in FIG. 5. For example, FIG. 6 shows the effects if the low-k and high-k layers of each repeating unit are equal in thickness. Both E_{L} and E_{H} are lower than in FIG. 5, E_{avg} is exactly half way between them and the ratio E_{L}/E_{H} remains exactly 2.5, the ratio of the dielectric constants. FIG. 7 shows the case that was depicted schematically in FIG. 4 case C, which is 2.5 repeating units of the capacitor insulator with the extra half-unit being another high-k layer. In FIG. 7, the ratio of the thickness of low k to high-k material in each repeating unit is varied through the full range, from all low-k to all high-k material. E_{avg} may be equal to E_{L} and E_{H}, respectively, at these two extremes. The ratio E_{L}/E_{H} may be exactly 2.5, the ratio of the dielectric constants. Field and surface charge density values for specific cases are given in Table 1.

According to one or more embodiments, and referring at least to FIGS. 5B, 6B and 7B (lower panels), the electric field profile as &function of distance from one capacitor plate to the other is plotted for representative values of the abscissa of FIGS. 5A, 6A and 7A. FIGS. 5B and 6B show the zeroth-order calculated fields as a function of distance in the z-direction when the insulator comprises four repeating units. Starting from z=0 at the left plate as in FIG. 4 case C, the structure is d_{H}(9 nm), d_{L}(1 nm), d_{H}(9 nm), d_{L}(1 nm), d_{H}(9 nm), d_{L}(1 nm), d_{H}(9 nm), d_{L}(1 nm). FIG. 7B shows the zeroth-order calculated fields as a function of distance in the z-direction when the fraction of low-k material in the insulator is 10%, as measured by thickness. Starting from z=0 at the left plate as in FIG. 4, the structure is d_{H}(9 nm), d_{L}(1 nm), d_{H}(9 nm), d_{L}(1 nm), d_{H}(9 nm). In FIGS. 5B, 6B and 7B, as in FIGS. 5A, 6A and 7A, the ratio E_{L}/E_{H} is exactly 2.5, the ratio of the permittivities or dielectric constants. Example field and polarization values for specific cases are given in Table 1. Electric field strengths are not depicted inside the conductive plates, but these may be theoretically zero.

According to one or more embodiments, mobile (or “free”) electric charges inside the conductor may accumulate near (e.g., <2 nm) the interfaces with the insulator to screen the fields present inside the insulator from encroaching inside the metal or conductive plate. This mobile charge may be, when the capacitor discharges, the carrier of stored energy in the capacitor's electric fields and polarized materials to an external circuit or device. According to one or more embodiments, the surface charge density [units C/m²] on the conductor at a conductor-dielectric interface is related to D, the electric displacement, by ρ_{s,free}(r)=n·D(r) or, in these 1-D cases, ρ_{s,free}(z)=n·D_{z}(z)=D_{z}(z), for r and z values at such interfaces, where n is a unit vector normal to the interface and pointing out of the polarized dielectric. In the simple planar layer geometries herein, n may take on the values +1 and −1. D_{z}(z)=D values were calculated using the equations in the form:

D_{H}=ε₀·k_{H}·E_{H}=ε₀·k_{H}·V·[n_{H}·d_{H}+n_{L}·d_{L}·(k_{H}/k_{L})]⁻¹,

and the corresponding relation for D_{L} using one of the equations. With ε₀=8.8541×10⁻¹² C·V⁻¹m⁻¹, k_{H}=25, k_{L}=10 and the values for d_{H}, d_{L}, n_{H} and n_{L} from FIGS. 5B, 6B and 7B, the surface charge densities ρ_{s,free,H} and ρ_{s,free,L} at the faces of the high-k and low-k layers, respectively, were computed according to one or more embodiments of the disclosure. These example data are summarized in Table 1.

TABLE 1
Electric fields in and surface charge densities at the surface of dielectric slabs,
zeroth-order approximation in a semi-classical calculation

| | | | | | | D, all | |
|---|---|---|---|---|---|---|---|
| Case in | E_{H} | E_{L} | D_{H} (C/m²) | D_{L} (C/m²) | k_{eff} | high-k | |
| FIG. 5-7 | (MV/cm) | (MV/cm) | = ρ_{s, free, H} | = ρ_{s, free, L} | (unitless) | (C/m²) | D, all low-k (C/m²) |
| FIG. 5B | 6.522 | 16.304 | 0.1444 | 0.1444 | 21.74 | 0.1660 | 0.0664 |
| FIG. 6B | 4.286 | 10.714 | 0.0949 | 0.0949 | 14.29 | 0.1660 | 0.0664 |
| FIG. 7B | 9.375 | 23.438 | 0.2075 | 0.2075 | 22.66 | 0.2290 | 0.0916 |

The D_{H} and D_{L} values may be equal due to the zeroth-order approximation equations. This may mean that either the high-k or the low-k layers may be placed adjacent to the capacitor's conductive plates and the capacitance may be the same, in this approximation. Since the material layer D values may be equal, from one of the equations and its D_{L} counterpart,

D=D_{H}=D_{L}=ε₀·k_{H}·V·[d_{H}+d_{L}·(k_{H}/k_{L})]⁻¹=ε₀·k_{L}·V·[d_{H}·(k_{L}/k_{H})+d_{L}]⁻¹.

Some manipulation gives

D/(ε₀·V)=k_{H}·k_{L}·[d_{H}·k_{L}+d_{L}·k_{H}]⁻¹ and

(ε₀·V)/D=d_{H}/k_{L}+d_{L}/k_{L},

which shows, in isolated form, the inverse-permittivity-weighted lump-sum distances from the high-k and low-k material thicknesses implied in the constant-D zeroth-order approximation in a system comprised of two dielectric materials. By lump-sum distances, it may be, as in some of the above equations,

d_{H}=Σd_{H,i} and d_{L}=Σd_{L,j},

regardless of the thickness, sequence order and proximity of the individual d_{H,i} and d_{L,j} thickness layers. For layered insulator systems comprised of three or more different kinds of dielectric materials, one of the equations may take the form

(ε₀·v)/D=d₁/k₁+d₂/k₂+d₃/k₃+ . . . , or

V/D=d₁/ε₁+d₂/ε₂+d₃/ε₃+ . . . =Σdᵢ/εᵢ, where εᵢ=ε₀kᵢ=ε₀ε_{r,i},

where i=1 n denote each of the different types of dielectric material and where each of the dᵢ values may be sums as in one of the above equations, within the constant-D approximation. By extension, if there are gradients of dielectric materials or in the permittivity property as a function of distance, z, between the capacitor plates,

$${ɛ}_{0} V / D = \text{?} \text{?} d z . \\ \text{?} \text{indicates text missing or illegible when filed}$$

According to one or more embodiments, table 1 may also show some other calculated quantities. The effective dielectric constant, k_{eff}, may be a composite or resultant k value calculated as if a capacitor had a single homogeneous block of insulator material rather than a multilayer stack of dielectric layers as the insulator. According to one or more embodiments, for a simple parallel plate capacitor with a homogeneous insulator, one or more of the above equations may reduce to

ρ_{s,free}=D=ε₀·k_{eff}·V/d,

where d is the total thickness of the insulator=the spacing between the capacitor plates. Solving for k_{eff} then allows calculation of the values in Table 1:

k_{eff}=ε_{r,eff}=D·d/(ε₀·V)=ρ_{s,free}·d/(ε₀·V).

According to one or more embodiments, one of the equations may also be used to calculate ρ_{s,free} and D for the case in which the capacitor insulator was a single piece of dielectric material with either a low-k value of 10 or a high-k value of 25. These two “all high-k” and “all low-k” values are shown in the right-most columns of Table 1 for the geometries of FIGS. 5B, 6B and 7B.

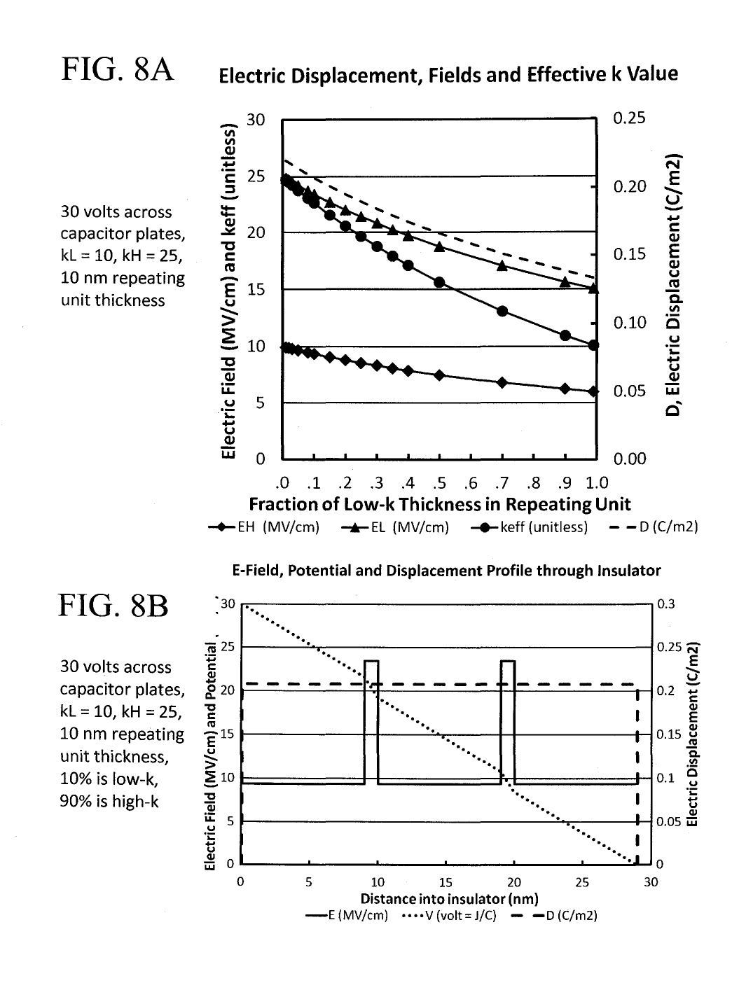

According to one or more embodiments, as a check on the internal consistency of the derivations herein and as a guide to design choices according to one or more embodiments of the disclosure, FIG. 8 plots D, k_{eff} and V for the multilayer dielectric stack of FIG. 4 case C; FIG. 8A augments FIG. 7A while FIG. 8B augments FIG. 7B.

According to one or more embodiments, high-voltage capacitor insulators with interfaces may be constructed interspersed within a main dielectric material. For example, each type of interface may serve one or more detailed roles or functions toward increasing k_{eff}, managing leakage current and/or preventing breakdown, all for the insulator as a whole. According to one or more embodiments, one or more types of interfaces may be used. According to one or more embodiments, adjacent and/or near-adjacent interfaces may work together to perform a detailed role. According to one or more embodiments, each type of interface may be a compound or complex interface, that is, having more than one distinguishable region. For example, at the outer portions of each interface may be a special transition zone effecting the actual interfaces with the neighboring first dielectric layer and second dielectric layer. These outer transition regions of an interface may be called a selvedge zone, selvedge region or selvedge layer by analogy with the term of art generally used in the cloth, fabric and textile field, wherein a selvedge feature may prevent a free edge of a piece of fabric from unraveling, fraying and the like. An example purpose of selvedge zones of a compound interface may be to minimize disruption of and unwanted interaction with the neighboring first and second dielectric layers. Another example purpose of selvedge regions is to electrically, chemically and structurally protect the interior functional core of the interface. Between and sandwiched by these selvedge regions, according to one or more embodiments, may reside a more central, functional core of the interface configured to serve one or more specific roles of increasing k_{eff}, managing leakage current and/or preventing breakdown, for the insulator as a whole, as described below.

According to one or more embodiments, the capacitor insulator, when constructed according to an example dielectric-layer(s)-and-interface repeating unit pattern described above, may include ratios of thickness d_{L} of the interfaces or interface layers 110 and d_{H} of the main dielectric layers 120 in the repeating unit of the insulator 100 such that d_{L} may make up, e.g., 1 to 20% of each repeating unit thickness, dᵣₑₚₑₐₜ, while d_{H} may make up the complementary, e.g., 99 to 80%, respectively. With reference to the electric field calculations above, it can be seen from FIG. 8A, the percentage range of d_{L} thickness may give k_{eff} values that are beneficially close to the k_{H} value. According to one or more embodiments, high-k is maintained while achieving high-E_{bd} of the capacitor insulator as a whole. Thus the repeating unit thickness ratios in FIGS. 5, 7 and 8 may be preferred while the ratio of FIG. 6 may not be preferred.

According to one or more embodiments, example operating electric fields may be such that E_{H} in a first or second dielectric layer 120 is approximately equal to and ranges up to about twice the E_{bd} of the corresponding bulk dielectric material. Since E_{bd} for Ta₂O₅ and HfO₂ are on the order of ˜5 MV/cm, in FIG. 5A it can be seen that 2 to 5 repeating units of dᵣₑₚₑₐₜ=10 nm thickness, having E_{H} from 13.0 to 5.2 MV/cm, meet this criterion for V=30 v. In FIGS. 7A and 8A, all fractions of interface (low-k) thickness meet the criterion for the same dᵣₑₚₑₐₜ and V.

According to one or more embodiments, operational E_{bd}′ values may be achieved in the high-k dielectric material layers 120 that are beneficially higher than the bulk E_{bd} value. In this example, all interface layers 110 are taken to have low k values (e.g., k_{L}=10), so the electric field E_{L} is concentrated at values, e.g., k_{H}/k_{L}=2.5 times higher than E_{H} in the dielectric layers 120, which are relatively high-k layers (e.g., k_{H}=25). Operating electric fields E_{L} within interface layers 110 in this example may be maintained less than, e.g., ˜30 MV/cm E_{bd} for, e.g., 1.2 nm thick Al₂O₃ layers, which has been arbitrarily taken as an upper limit to E_{L}. For example, an upper limit to E_{L} may be adjusted for different interface additive species or materials based upon experience or detailed calculations. In FIG. 5A it can be seen that 3 or more repeating units of, e.g., dᵣₑₚₑₐₜ=10 nm thickness are required to meet this criterion, while in FIGS. 7A and 8A, all fractions of interface (low-k) thickness meet the criterion for the given dᵣₑₚₑₐₜ and V. According to one or more embodiments, example insulators may be scaled to any thickness so as to stand off any voltage while keeping capacitance consistent with values implied in FIGS. 5-8.

Capacitance may be wholly determined by ρ_{s,free} on the capacitor's plates, which in turn is wholly determined by D, the electric displacement in the insulator. Note that the D values in FIG. 8 are significant fractions (12 to 20%) of a Coulomb per square meter, which may be beneficially large for charge and energy storage. As can be seen in FIG. 8B, D is constant throughout the insulator, which may mean that repeating units can be added into the stack ad infinitum without affecting D, provided that V is increased proportionately to the increase in d due to adding more repeating units. Adding more repeating units increases the voltage that can be stood off across the capacitor's plates, which increases the energy that can be stored proportional to V² while maintaining the same D=ρ_{s,free} and capacitance per square meter, which is equal to ε/d.

According to one or more embodiments, provision may be made to avoid undesirable electric breakdown by limiting the acceleration length of free electrons such that terminal velocities of accelerated electrons correspond to kinetic energies Eₖ less than required to efficiently ionize constituent atoms of the insulator by electron-impact; such ionization thresholds range from, e.g., 3 to 18 eV. This may primarily concern the thickness d_{H} of the main high-k dielectric layers 120, wherein such acceleration may occur, and the total voltage drop across that distance. FIG. 8B shows the electric potential V across high-k layers 120 in volts for operational fields near the goals mentioned above, which are E_{H} in layers 120 approximately twice E_{bd} of the bulk value for the main dielectric and E_{L} values in at least some types of interfaces and interface layers 110 that are substantially similar to the transistor gate dielectric breakdown values. A free electron may be accelerated to a kinetic energy Eₖ (eV) equal to that number of volts. FIG. 8B shows voltage drops of 9 to 10 volts across d_{H}=9 nm thick high-k layers (E_{H}≈1 volt/nm), and this is considered aggressive but safe, even though an electron's Eₖ may be >3 eV. An electron accelerating in such a layer will experience several kinds of scattering and energy losses to the atoms in the material, and, among the high-k dielectric materials chosen, the lowest ionization potential will be considerably greater than 3 eV. According to one or more embodiments, it is intended that the electron never accelerate to a ballistic propagation mode before reaching an interface or other structure at which it may lose energy and become strongly bound again. Nevertheless, this approach alone may require an undesirably fine a pitch of repeating unit for a capacitor insulator having sufficient thickness for high voltages, such as 100 v, 500 v, 1,000 v, 10,000 v, 100,000 v and higher contemplated herein. The situation may be improved if electrons never became free to begin with, which in part may mean, leakage electrons remain in lower energy hopping, tunneling or other modes of conduction until such time they could be de-excited and/or recombined in strongly bound states. Failing that, and some electrons reach a transitional energy on a threshold of ballistic conduction, which may comprise very undesirable pre-breakdown phenomena, it would be desirable if further scattering with atoms or structures in the capacitor insulator would limit their terminal velocity or Eₖ to values that could be later slowed or decelerated by special structures designed for that purpose.

According to one or more embodiments, a framework may be provided in which the above-mentioned pre-breakdown phenomena of electron conduction, and others, may be dealt with. According to one or more embodiments, amorphous materials for dielectric layers 120 are used. Amorphous materials may offer no regular, uniform, periodic or unimpeded propagation paths for either ballistic or pre-ballistic electrons. Electron Eₖ loss to scattering may be much greater than in crystals, thus resulting in a lower terminal velocity of drifting or hopping/tunneling electrons in a prevailing electric field. According to one or more embodiments, the structure of main dielectric layers 120 and interfaces 110 may allow construction of special structures to mitigate and handle leakage electrons and holes. It is assumed for example purposes only that leakage current may be unavoidable, in some sense, at high enough fields, simply due to imperfections in materials and other aspects. Charge leakage in capacitor insulators may be related to pre-breakdown phenomena, at least in extreme cases.

According to one or more embodiments, higher field extension of one or more permissible kinds of leakage that do not threaten pre-breakdown is contemplated. Accordingly, high-voltage capacitor insulators may be provided with interfaces interspersed within a main dielectric material, where in the interfaces may provide a range of leakage and pre-breakdown mitigation functions. As mentioned above, an interface may comprise a functional core and selvedge regions. Also provided are interfaces having no “core” or distinguishable selvedge regions but that include distributions of additive atoms dispersed within first dielectric 120 much like a diffuse dopant, which may serve a purpose of improving an atomic structure, composition, electron band structure or other feature of dielectric layer 120 with respect to, for example, slowing electrons so as to prevent unwanted pre-breakdown phenomena such as ballistic propagation of electrons, among others. Within a type of interface comprising a core and selvedge regions, a selvedge region may serve to stabilize or protect a core structure that might be characterized as more delicate or complex than otherwise may be appropriate within a high-voltage insulator. Several roles and functions of the selvedge were given above.

According to one or more embodiments, selvedge or outer transition region of a compound interface may include, at least in part, for example, Mg, Ca, Sr or Ba atoms (or combinations thereof), inserted, delivered or co-deposited with the atoms that make up the outer edge of the neighboring first (or second) dielectric layer simultaneously while the first atoms that make up the central functional region of the interface are inserted, delivered or co-deposited. Regardless whether these three sets of atoms are, for a time, co-arriving or they are sequenced into/onto the outer region of the interface, one kind at a time, they may interact and intermix at least on a 1-atom-thick scale. At least three types of selvedge atom (e.g., Ca) distributions may exist. For example a) selvedge atoms only within neighboring dielectric 120, b) selvedge atoms only within the interface core edge and c) selvedge atoms only at a boundary of those two regions; but combinations of them are likely. Taking calcium, for example, calcium may upon arrival immediately assume a +2 valence state, which brings these atoms to an argon-core, filled-electron-shell state which is spherically symmetrical. In this state, Ca²⁺ ions can simultaneously bind electron density tightly and form strong Ca—O chemical bonds that tend to be mostly non-directional. A band structure improvement function of Ca is reflected by calcium oxide itself, which has a large electronic energy band gap (˜10 eV), confirming a tendency to pull electrons into low-lying, strongly-bound levels of the band structure. The non-directionality of Ca—O bonding means that the directionality of bonding may not be strongly preferred or influenced by Ca itself but mostly by the locations of the atoms to which it will bond. Although Ca may form the strongest bonds in the proportion and pattern O—Ca—O, bonding with more (CaO₃) or fewer O atoms is quite strong, and the O atoms can be in almost any direction in which they do not sterically hinder each other. These characteristics of calcium-oxygen electronic structure and bonding mean that calcium may “tie up” electrons into strong bonds and low-lying electronic states which otherwise might be loosely bound and contribute to leakage or pre-breakdown phenomena. These characteristics also mean that calcium will tend to immobilize most kinds of atoms at this outer interface, preventing or reducing chemically driven inter-diffusion and chemical reaction. The bonded Ca atom (no longer an ion) is relatively large in radius, as well, which further hinders not only Ca diffusion and intermixing away from the selvedge but also hinders intermixing of atoms native to dielectric layer 120 and the interface 110 core. Mg, Sr or Ba can be used to vary this atom-size physical blocking effect. By extension from the described example functions of a selvedge region of an additive-bearing interface according to one or more embodiments, and the example one or more additives and their example working aspects given, those skilled in the art will appreciate that many other additives may be used to help form a selvedge region and there may be other example functions and/or working aspects, attributable at least in part to a selvedge region. As such, the particulars of the example selvedge region should be taken as an example only and not to otherwise limit the scope of the disclosure.

According to one or more embodiments, inner or more central core atoms in an interface may manage electrons, and electron holes that ideally are close by, to prevent unbalanced charge build-up. According to one or more embodiments, a type of interface core is an electron deceleration layer, which may also be an electron stopper layer, a kinetic energy absorbing layer, an avalanche dissipating layer, a cascade quenching layer and/or a leakage path blocking layer. Other functions of an electron deceleration layer, or other cores or layers in other interfaces, may be carrier (electron and hole) recombination, charge accumulation (for example, hole accumulation, ion accumulation, electron accumulation and so forth), charge lateral bleed off, and electronic energy de-excitation (excitons, polarons, and the like). Considering electrons propagating at Eₖ values near a threshold for ballistic transport, such an electron has almost lost contact (coulomb interaction) with atomic potential wells because its kinetic energy is so high that the moving electron is not strongly attracted or influenced by the atom potentials in its path. This range of kinetic energies in approximately 3 eV to 100 eV but more critically 5 eV to 50 eV. At the lower end of the range (<˜5 eV), an electron may be strongly interacting with local atomic potentials. Above about 50 eV kinetic energy, an electron is too energetic to likely be slowed or stopped—a goal is to slow and prevent electrons from acquiring as much as 30, 40 or 50 eV kinetic energy, after which they are on their way to the positive capacitor plate electrode, probably unstoppably. At this Eₖ level, a heavy-element conductive oxide may be used as an electron deceleration medium or an electron stopper layer. A favored composition for an interface additive for electron deceleration in the 5-50 eV kinetic energy range is WOx, where x ranges from 1.4-3.1. Lead (Pb) and bismuth (Bi) are also possible, with similar ranges of x for their O stoichiometry, recognizing that electrical conductivity and other properties of these materials strongly depend upon crystal structure, defect density and packing density in addition to oxygen content. Thus these layers may exhibit substantially metal-like electrical conductivity or be substantially dielectric in character. The principle of operation relies on the large cross section for electron collision with the high-Z (W, Pb or Bi) atom core, where bound electrons have similar kinetic energies as ballistic electrons moving at 10 to 35 eV kinetic energies.

According to one or more embodiments, the high-Z atoms may have a variety of oxidation states, chemical bonding patterns/partners, geometric bond strain degrees and similar “defects”, which all together give rise to a wide span of occupied and unoccupied atomic and molecular electron states. It is preferred that such a high-Z layer be thick enough that it will be unlikely for a 5-50 eV electron to propagate through the layer without significant interaction with at least one high-Z atom. A mechanism for relaxation of high-Z atoms after receiving excitation may be Auger de-excitation, which may liberate one, two or more low energy electrons. Provision may be made to trap and further thermalize these secondary electrons. Heat is the desired by-product of this deceleration process. Considering the foregoing and other possible interface core functions, not binding or limiting the disclosure as to atomic-scale mechanism, electrons and holes may have less than a certain level of kinetic or potential energy may be decelerated, stopped or recombined by one or more interface layers, thus moderating energetic leakage conduction and reducing, quenching or preventing cascade or avalanche breakdown. Different kinds of interfaces and compound/complex interfaces are contemplated within the disclosure, some kinds more suited to one aspect of preventing or interrupting cascades and avalanches and other kinds more suited to other aspects of good insulator performance, such as reducing leakage current or increasing k value. It is contemplated that several different types of interfaces may be used in combination to provide improved performance of a capacitor insulator of the disclosure.

Those skilled in the art will appreciate that the description of all FIGS are not to be construed as limiting the scope of the disclosure. For example, the features of the zeroth-order semi-classical calculations discussed herein are for example purposes only to define an example instantiation of one or more embodiments of the disclosure. Those skilled in the art will appreciate that alternate calculations using the equations given may be used. In addition, first principles calculations capable of elucidating quantum and chemical effects may reveal “relaxation” of the extremely high electric fields localized in very thin (e.g., ˜1 nm) interface layers. Such a system may tend to relax by lowering overall energy, within constraints of chemical bonding, atom mobility and the like. Some relaxation of the dielectric layers plus interfaces structure may occur at the time of (field-free) growth of the insulator.

According to one or more embodiments, other relaxation may occur, e.g., only when a strong electric field is applied. Some forms of relaxation may be irreversible. According to one or more embodiments, a fabrication approach may be used of “seasoning” the capacitor insulator structure via a controlled initial application of electric fields (similar to “poling” known in the art of fabricating ferroelectric and piezoelectric materials), possibly at reduced or elevated temperatures and at other desired conditions, such as rate of increase of the field, dwell time at field and others.

According to one or more embodiments, to the extent that such relaxation is irreversible, the insulator may then be used in a unipolar capacitor, which may have inferior performance if charged with opposite polarity. At least two example mechanisms of relaxation may be seen. For instance, expressed in semi-classical terms, 1) the D_{H}=D_{L} boundary condition near dielectric-dielectric interfaces may be broken and 2) εᵣ=k may become both spatially and field dependent (inhomogeneous and non-linear) near dielectric-dielectric interfaces. The electronic structure, chemical bonding, atom nuclear positions and vibrational potential wells of an additive material and/or a reacted or intermixed additive material may change under high electric fields when the local permittivity of these materials is low (e.g., ˜3 to ˜10), such layers may be ultra-thin and their total percentage in the overall insulator may be small (see the above equations for E_{H} and E_{L} in terms of layer thicknesses and k values).

According to one or more embodiments, these field-influenced quantities may be exactly the same ones that go into a proper calculation of the dielectric susceptibility tensor of any material. Provided the size of other features, for example d_{H} of the main dielectric layers, in the regions surrounding any ultra-thin layers and dielectric-dielectric interface layers are of much greater than molecular dimensions, the E, D, etc. parameters may return to the semi-classical values in the regions away from the ultra-thin layers and interfaces. Deviations from the semi-classical behavior calculated for FIGS. 5-8 may be compatible with or beneficial to the function of one or more embodiments of the disclosure. For example, some such relaxations of the insulator layer and interface structure may have the effect of increasing the k_{L} value or the polarizability of the interface without decreasing its contributions to the high-E_{bd} properties of the insulator as a whole, which may tend to increase k_{eff} of the capacitor insulator as a whole.

According to one or more embodiments, the capacitor insulator 100 may include layers 120 of high-k dielectric material and ultra-thin interfaces 110 of additive material. According to one or more embodiments, insulator 100 and capacitor 200 may have compositionally sharp interfaces where layers and interfaces abut or join, both dielectric-to-dielectric and dielectric-to-conductor interfaces. Compositionally sharp interfaces may be broadly described as having little intermixing of atoms unique to one layer with or into abutting or adjoining layers.

According to one or more embodiments, insulator 100 and capacitor 200 may have geometrically planar (flat) interfaces at the atomic scale, where layers and interfaces abut or join, both dielectric-to-dielectric and dielectric-to-conductor interfaces. According to one or more embodiments, if interfaces are not flat, a) the thinner layers may not have enough thickness at the thinner points to exhibit definable material structure and properties and b) the capacitance-related effects may be dominated by points of closest approach of two opposing layers through an intermediate layer, and these points may give an effect of substantially smaller electrode plates than the geometric area of the whole plate. Since this flatness may be at the atomic scale, gently curved or spherical capacitor geometries may still be within the scope of one or more embodiments of the disclosure.

According to one or more embodiments, insulator 100 and capacitor 200 may have dense packing of atoms at interfaces, both dielectric-to-dielectric and dielectric-to-conductor interfaces. According to one or more embodiments, the interiors of layers and interfaces may be densely atomically packed.

According to one or more embodiments, insulator 100 and capacitor 200 may have substantially strong chemical bonding between at least some of the chemical constituents (e.g., atoms, ions, molecules, unit cells, formula units, etc.) in and throughout interfaces where layers abut or join, both dielectric-to-dielectric and dielectric-to-conductor interfaces.

According to one or more embodiments, insulator 100 and its material layers, particularly its ultra-thin additive-bearing interfaces 110, may exhibit primarily covalent bonding of all atoms. Such bonding structures may be more effective in stopping, hindering or recombining energetic free electrons than ionically-bonded structures.

According to one or more embodiments, insulator 100 and its material layers, both its additive-bearing interfaces 110 and its main dielectric layers 120, if a metal oxide-based composition, may exhibit maximum oxygen concentration consistent with full bonding (e.g., non-bonded or interstitial oxygen may be absent) of oxygen to metal(s). For example, the oxygen:metal ratio may be as high as possible consistent with known stoichiometries of the chemical compound and valences of the constituent atoms. According to one or more embodiments, such maximum oxygen stoichiometry may promote covalent bonding over ionic bonding, may increase the electronic bandgap and may reduce the occurrence of multiple types of defects, both electronic and structural. According to one or more embodiments, maximum oxygen may apply to, for example, mixed-metal oxides as well as single-metal oxides.

According to one or more embodiments, insulator 100 and its material layers, both its interfaces 110 and its dielectric layers 120, may exhibit amorphous structure. For example, such a structure may provide no grain boundaries, which may be percolation or hopping pathways for, e.g., electrons, electron holes and light ions such as H⁺, Li⁺ and similar. Amorphous structures, if densely atomically packed, may rarely exhibit a “whole” defect like a lattice vacancy on an atom position in a unit cell, nor an interstitial atom, but may tend to partially fill or relieve such nuclear-position imperfections.

According to one or more embodiments, first-principles ab initio density-functional theory calculations in the local-density approximation using local-orbital expansions may show why these amorphous materials have substantially no “dangling bonds”, unpaired electrons (radicals) or non-bridging (terminal) oxygen atoms. They may be nearly as dense as the single crystal and the dominant, strong covalent bonding usurps all available valence-shell electrons into a plurality of inter-atomic bonding orbitals or states, which may increase the overall strength of the bonding of the material. The band gap of the amorphous insulator may be nearly the same as in the single crystal, and there may be substantially no intra-gap states, either occupied or unoccupied.

According to one or more embodiments, insulator 100 and its material layers, both its interfaces may include additives 110 and its main dielectric layers 120, may be compositionally pure, with, e.g., <<1% atomic fraction content of species of atoms not called for in the nominal chemical formula of the dielectric material, the additive(s) and desired chemical combinations of them. According to one or more embodiments, low-mass, low-atomic number (Z), highly diffusionally mobile atoms such as H and Li are avoided.

According to one or more embodiments, one or more kinds of spatial aperiodicity may be in the pattern of the plural dielectric-layer-and-interface repeating units combined into a structure. For example, starting with a basic plural repeating units structure, which may be constructed according to the pattern described above that may include ratios of thickness d_{L} of the interface layers 110 and d_{H} of the main dielectric layers 120 in the repeating unit of insulator 100 such that d_{L} makes up 1 to 20% of each repeating unit thickness, dᵣₑₚₑₐₜ, while d_{H} makes up the complementary 99 to 80%, respectively. From this base pattern, the thicker main dielectric layers may be varied in thickness “randomly” or pseudo-randomly so as to place the thinner interface layers not on a regular distance interval or period.

According to one or more embodiments, the thickness of the interface additive layers may be increased (or decreased) by a small amount each time such a layer is fabricated. The cumulative effect of several 10% changes of thickness, for example, may be to displace the interface positions locally from registration or phase-consistency with the interface positions some distance away. After compounding such small thickness changes sufficient to produce, for example, a 90° out-of-phase anti-periodicity, then optionally the direction or sense of the thickness changes may be reversed, so as to maintain the overall 1 to 20% of interface additive material proportions of the overall insulator, or other percentage as may be desired. Those skilled in the art will appreciate that there may be other ways of changing an insulator repeating unit thickness, and thicknesses of dielectric layers and interfaces, in order to achieve the desired goal of destroying the long-range periodicity of the array of interfaces. According to one or more embodiments, without being bound by any particular theory, it may be desirable to break the long-range periodicity of the insulator's dielectric layer and interface structure to avoid forming extended or delocalized electron states that span the insulator in the direction of the externally-applied electric field. Such extended electron states may, if occupied by electrons, lead to increased leakage current and/or lower breakdown fields of the insulator. For example, such electron states may increase tunneling conduction by providing resonant tunneling verses the less efficient “free-space-like” tunneling. There may be other atomic-scale mechanisms by which nanometer-scale perfectly-periodic lattices may promote electron delocalization and transport, which is thought to be undesirable for a high-field insulator. Therefore, without being tied to any particular mechanism, which may vary from material to material and for other reasons, one or more embodiments may include plural dielectric-layer-and-interface-units combined into structures which break Cartesian space periodicity or regularity. Recall that the last mentioned “dielectric layer” may include two, three or more distinct dielectric layers, having interfaces between them, only at least one of which need be an additive-bearing interface of the invention. One or more embodiments may include plural dielectric-layer-and-interface-units combined into structure variants which may break momentum-space (k-vector) patterns which may promote unwanted electron delocalization and transport.

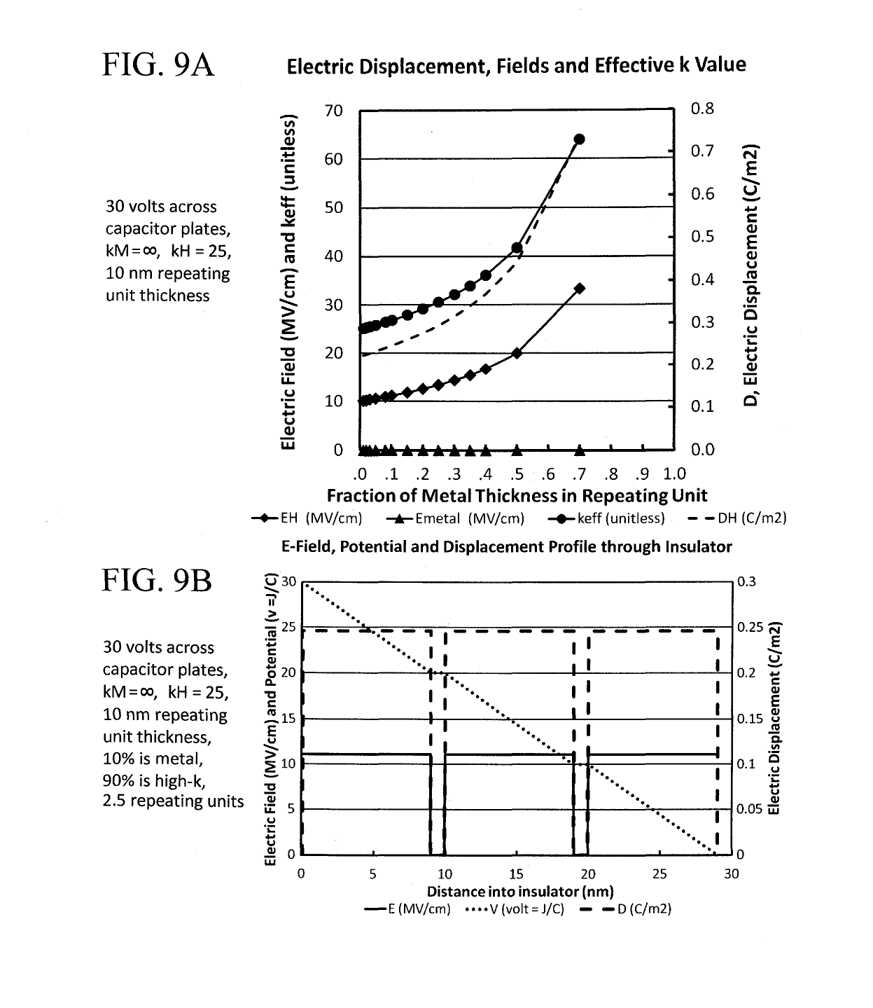

According to one or more embodiments, pure metal or conductive material additives may be substituted in place of some or all of substantially insulating, even dielectric, interfaces 110. Such metal layers or interface structures may be substantially electrically isolated or “floating”, or may be provided with a drain or current pathway to an external sink. For example, considering first the case of a truly substantially electrically isolated or “floating” structure, this may mean, for example, that the layer or structure is substantially surrounded by dielectric materials or dielectric layers at least in a direction(s) perpendicular to the imposed or locally prevailing electric field. For another example, “floating” may mean substantial absence of electric current-flow or charge-flow pathways to either capacitor plate or to another low-impedance, fixed-potential body. It will be appreciated by those skilled in the art that a body (such as a layer or an interface of the present invention) may not normally be completely “electrically isolated”, since lines of electric flux originating on charges elsewhere may impinge on or interact with the body; likewise, it may not be possible for a body to be completely “floating” in an electrical current sense, since most practical surrounding dielectrics may exhibit some leakage current in an electric field. Nevertheless, the term “floating” is used herein to signify the approximate state indicated heretofore. In such conductor layers, E and D may be zero, according to the semi-classical schema. An example calculation may be performed of the dielectric performance of such a metal- interlaced insulator for the structure of FIG. 4 case C, in which metal layers have been substituted for the “k_{L}” layers 110. The result is plotted in FIG. 9 for V=30 v, dᵣₑₚₑₐₜ=10 nm and all other parameters the same as in FIG. 8 except that dielectric constant kₘₑₜₐₗ=∞. As can be seen in FIG. 9B, the constancy of potential V within the metal layers (Eₘₑₜₐₗ=0) may force an increase in E_{H} compared with its value in FIG. 8B, which may be necessary so that one of the above equations is satisfied. For that same reason, as well as the convention to use d as the spacing between the plates rather than the thickness of only the dielectric material, k_{eff} may be higher in FIG. 9A. Nevertheless, the high-k performance of the insulator may be superior to an insulator in which a low- or mid-k dielectric material is used for the interfaces 110.

According to one or more embodiments, the metal or conductor layers may be in the semi-classical calculation, infinitely polarizable with zero energy input. According to one or more embodiments, such thin layers of metal may become “saturated” or depleted regarding separation of mobile charges when subjected to high fields such as depicted in FIG. 9 or higher. The propensity for mobile charge depletion may be influenced by the choice of the metal. Metals may provide only one electron per atom if, e.g., there is only one electron in excess of the last completed inert-gas shell (e.g., Na, K, Rb) or one in excess of the last completed “d” shell (e.g., Cu, Ag, Au), while metals nearer the middle of the transition metal series may provide, e.g., 2, 3, 4, 5 or 6 s-d hybridized electrons per atom. For non-metallic conductors, for example conductive oxides such as InOₓ, SnOₓ, WOₓ and RuOₓ, similar considerations may apply regarding the density of (occupied) states of mobile electrons. In case of charge separation depletion, the cost in energy of polarization may not be zero. E and D fields may exist within the metal or conductor.

According to one or more embodiments, the field-stressed metal and conductor layers for increasing E_{bd} is contemplated. Metallic-like conductivity may still exist in the plane of the metal layer even though conductivity may be severely reduced normal to that plane. The in-plane conductivity may provide lateral uniformity of electric fields within the insulator in case of fluctuations in those fields during, for example, rapid charging or discharging of the capacitor. Such conductive layers may have excellent ability to “quench” electron cascades or avalanches involved in catastrophic breakdown.

According to one or more embodiments, at least a portion of metal layer 110 may be the chemical or compositional transition region to the fully-oxidized or nitrided dielectric. Some oxygen or nitrogen may penetrate the periphery of the metal layer. Thus, metal-additive-bearing interfaces 110 may be categorized as compound or complex, optionally including, at least in part, intermixed regions and composition gradients, on one or both sides of a metal-rich portion. Such transition regions between covalent and metallic bonding may have diverse electronic states, occupied and unoccupied, which may be traps for electrons and holes. According to one or more embodiments, use of such metal layers with free electrons may require excellent quality of dielectric material sandwiching the metal. Also, such a structure may be “lossy” for high frequency alternating current (AC) use, this may be a matter of little concern for capacitive energy storage.

According to one or more embodiments, for example, in which a substantially electrically isolated or “floating” pure metal or conductive interface 110 is provided with a drain or current pathway to an external sink, the current pathway or the external sink may be a very high-impedance electrical path. The added charge drain to otherwise floating layers 110 may remove free charge which may accumulate at interface 110. Free charge may mean, in a Gauss' Law sense, a charge which is not balanced by opposite charges with a region of interest (a Gaussian surface). Free charge, even if immobile, may distort or change electric field strengths within insulator layers carefully designed according to the above or other electrostatic analysis, which may be detrimental or even catastrophic for capacitor performance.

According to one or more embodiments, a method of fabricating such a bleed-off conductive path to a sink may be explained with reference to FIG. 5, which shows an cross-sectional cut view of a completed single capacitor 200 stack. According to one or more embodiments, a cut may optionally be made in order to singulate or separate capacitor dice from many others made all at the same time on a larger substrate 210. According to one or more embodiments, a coating of a highly insulating material may be encapsulated or added over such an exposed face of capacitor 200, to protect from environmental contamination, incidental damage and short-circuiting the otherwise exposed capacitor plates 220 and 240. According to one or more embodiments, however, a highly resistive but still slightly conductive coating may be applied to the same exposed face of capacitor 200. According to one or more embodiments, narrow stripes of resistive material may be applied only across selected areas of exposed capacitor insulator 100, lapping onto narrow sections of electrodes 220 and 240. Either way, a highly resistive electrical path may be created which connects electrodes 220 and 240 but also touches exposed edges of insulator 100 and engages and electrically contacts exposed edges of metallic or conductive layers 110. As indicated above, there may be 10s, 100s or 1000s of edges of metallic or conductive layers 110 exposed and therefore contacting the applied resistive element or layer. The resistance of the applied resistor may be only as low as it needs to be to bleed off excessive free charge accumulating on (otherwise) floating structure 110. For example, in a zeroth-order approximation, if a particular interface 110 typically attains a potential of 5,000 volts relative to the positive plate of 200 and an excess electron current of 1 microampere may need to be drained from that interface, then Ohm's Law indicates that a path having a resistance of approximately R=V/I=5×10⁹Ω may be offered to that interface layer to bleed off the excess charge. A more detailed calculation may be readily performed. Many materials such as, e.g., SiC, TaN and others may provide such resistance values in thin films applied, for example, by sputtering.

According to one or more embodiments, capacitor insulator 100 of FIG. 2 may include a repeating series (or other appropriate structure) that may include dielectric layers 120 with amorphous HfO₂ or Ta₂O₅ as a high-k dielectric material and interfaces 110 with amorphous Al₂O₃ as an additive material. However, those skilled in the art will recognize that other single-metal oxides as well as complex oxides, metal nitrides and other insulating compounds may be grown (e.g., by BTD discussed further below).

According to one or more embodiments, materials for interfaces 110 may be chosen from the low-Z (low atomic number) oxide-forming metals and semi-metals, such as, e.g., Li, Be, B, Mg, Al, Si, Ca and possibly Sc, Ti and V, among other metals. Oxides formed from such metals may be dominantly covalently bonded when fully oxidized, although this is not intended to limit the scope of the disclosure. Nitrides of these same metals may also be used. According to one or more embodiments, mixed-metal oxides of these same metals may be used and may be readily made (e.g., by BTD).

According to one or more embodiments, non-metal compounds of low-Z elements, such as BN, C(diamond), B₄C and so forth may also be used and may have lower dielectric constant, and thus may be thinner than the metal oxides listed by example above. For the high-k dielectric layers 120, hundreds of material compositions are possible. For example, it may be desirable to replace HfO₂ or Ta₂O₅ having k≈25 with a higher k material. According to one or more embodiments, all compositions of high k materials may be permitted in a capacitor insulator that includes dielectric layers with additive-bearing interfaces and may fall within the scope of the disclosure. Examples of such high-k materials may include but are not limited to SrTiO₃ (k ˜200), BaTiO3, (BaSr)TiO3, LiNbO3 and so forth. According to one or more embodiments, these materials may be deposited in amorphous form, at least to avoid crystalline grain boundaries, which may destroy the atomic-scale flatness for fabrication of ultra-thin additive-bearing interfaces. According to one or more embodiments, the amorphous forms, if densely atomically packed and fully oxidized, may have k values similar to their crystalline counterparts. According to one or more embodiments, amorphous layers may be used to reduce lattice mismatch strain that may occur under certain circumstances in crystalline hetero-epitaxial multilayer dielectrics, the effects of which, in general, it may be desirable to avoid or utilize, at will.

According to one or more embodiments, amorphous structures may be used to give more scope for avoiding ferroelectric phases of these high-k materials. Ferroelectric switching may be undesirable in an energy storage capacitor application, as no external circuit may exist during discharge of the energy to drive the spontaneous polarization out of the charged-up storage state. However, even amorphous compounds may exhibit ferroelectric states, so care may be exercised.

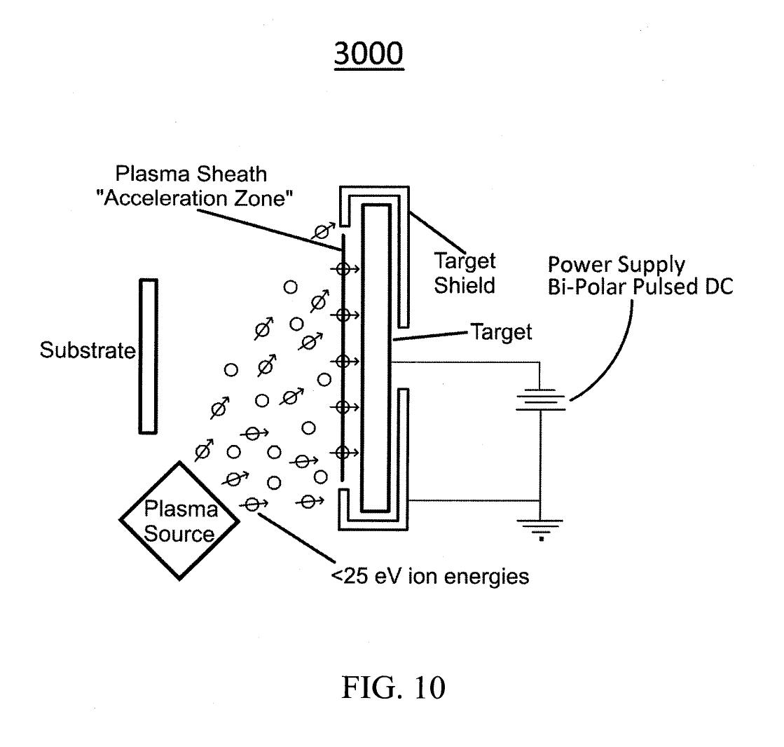

According to one or more embodiments, an advanced plasma sputtering technique may be utilized known as Biased Target Deposition (BTD). In BTD, a form of vapor deposition performed in a partial vacuum, a low energy ion source or downstream plasma flood source may be directed at a negatively biased sputtering target as shown in FIG. 10. The maximum kinetic energy (typically <25 eV) of the ions is less than the sputter threshold of the vacuum system materials. No effort is made to capture all of the ions on the target because ions that miss the target may not generate unwanted sputtering. The ion beam/plasma flood can be much broader than the target to improve illumination uniformity. A plasma sheath may develop at the surface of the negatively biased target that accelerates positive ions entering the sheath toward the target to produce sputtering. Because the sheath is very thin (e.g., ˜2 mm) compared to the spacing between the ion source and target, the target bias may have no substantial effect on the ion trajectories from source to target. Hence, for constant plasma source operation, the illumination profile and the ion current reaching the target are nearly independent of the target voltage. A grounded shield surrounds the target to prevent undesired sputtering of the target mounting hardware that is also biased. DC, RF or pulsed DC target bias may be used depending on the target material and desired process. A large range of target voltages (˜50 to 5000 V) can be used while maintaining beneficial deposition rates. The selection of the target voltage, by virtue of its impact on sputtered atom ejection energy and hence adatom energies, has a profound impact on the atomic scale mixing at thin film interfaces and the overall roughness of the growing film. In addition, the ion or plasma source may be capable of operating over a broad range of process pressures (e.g., ˜1×10-4 to 1×10-2 Torr), allowing control of the sputtered atom kinetic energy by thermalization via scattering in the background gas at the higher end of this pressure range.

According to one or more embodiments, a second, low energy ion source (an assist source) may be directed at the substrate to modify the properties of the growing film. Non-reactive assisting ion energies of order 5-15 eV may be used in creating smooth films. Reactive assist ions may be used (e.g., ions of O₂ and N₂) to create dielectric films from metallic targets. This source may also etch, clean and modify surfaces prior to deposition. Many types of ion/plasma sources could be used for BTD as the sputter target illumination source and/or the ion assist source, but early work used end-Hall gridless plasma sources sustained by a thermionic hollow cathode, allowing between 5 and 20 amperes DC discharge and ˜2 amperes of ions, some of which was collected on the sputter target(s). Newer types of plasma sources providing more ion current and hence faster film deposition rates have been developed.

According to one or more embodiments, high purity copper deposition by measurement of resistivity of the films and spintronic applications may be used. A number of the modes of use and advantages of BTD may be described as, for example bi-polar pulsed DC target bias for dielectric deposition, alloy co-sputter deposition, control of chemically reactive neutral species, control of substrate electrostatic discharge (ESD) damage and dynamic film uniformity monitoring and correction, among other features.

According to one or more embodiments, BTD capabilities in reactive sputtering of dielectric films from the component metal targets may be used to make the capacitor insulator. For example, in reactive sputtering, metal vapor may be sputtered from the pure metal target, and oxygen, nitrogen or other dielectric-forming element may be introduced into the sputtering chamber as a gas. This gas may be piped through a plasma or ion source associated with the BTD apparatus (e.g., FIGS. 5 and 6), in which case it may become ionized and the ions accelerated to either the sputter target or to the growing film on the substrate, thus increasing the reactivity of the gas, for example, by collisional dissociation at those respective surfaces. According to one or more embodiments, e.g., for O₂ gas which is generally reactive with most metals, the gas may be admitted to the sputtering chamber as a background, ambient partial pressure or directed with a nozzle toward the growing film.

According to one or more embodiments, reactive, dissociated neutral atoms or radicals (molecular fragments) of the dielectric-forming gas that rebound from the one or more sputter targets may be used to provide a hyper-oxidizing or hyper-nitriding environment at the growing films, which may assure a fully saturated oxide or nitride stoichiometry. The kinetic energy of such neutral atoms or radicals may be elevated in the 1 to 25 eV range and controlled, and this energy may provide a densification and surface-leveling function on the growing dielectric film. Regardless of how they are introduced into a sputtering apparatus, such reactive gases may disturb or disrupt some methods of sputtering, if only due to the excess or incidentally unused gases being liberated generally through the sputtering chamber. In BTD the plasma flood may uniformly cover the target with ion current density and issues with so-called “target poisoning”, that is, adsorption of the reactive gas, such as O₂ or N₂, on the target metal surface with concomitant drastic reduction in sputter rate, may be solved. In contrast, magnetron sputtering cathodes may exhibit various forms of “hysteresis” in their discharge behavior as a function of reactive gas flow, which may limit the practical process “window” accessible. The hysteresis may be caused by the magnetic fields above the cathode, which influence the plasma density and ion current density over the face of the cathode. Regions with ion current density gradients may cause variable and unstable “poisoning” of the targets by the reactive gas, which reinforces the hysteresis behavior and further degrades process stability. In BTD, target poisoning may still occur, but it may be uniform all across the target surface and stabilizes to changes in process conditions quickly (e.g., <<1 sec) and remains stable. Notwithstanding the fact that O₂ gas or other oxygen-delivering gas may poison sputter targets and reduce deposition rate, in most reactive sputtering processes it may be preferred to conduct the process with a modest excess of oxygen partial pressure (or chemical potential) over the minimum needed to oxidize the metal to fully-oxygenated stoichiometry of the resultant thin film chemical compound. This preference is possible because most oxide thin films may self-reject any excess oxygen over the amount needed to form the fully-oxidized stoichiometry. The energetic (0.05-5 eV) adatom species being deposited and the low-energy (0.1-50 eV) ion or neutral assist bombardment of the growing film provided by BTD tends to remove loosely bonded species of all types, including oxygen, thus facilitating the rejection of stoichiometrically excess oxygen. Because BTD makes the target poisoning problem optimally manageable, as described above, it is possible to find and maintain the minimally-excess oxygen partial pressure needed to oxidize the metal to fully-oxygenated stoichiometry, while not having excess target poisoning which would slow deposition rate.

According to one or more embodiments, the above described BTD processes may result in amorphous Al₂O₃ and amorphous Hf02 when performed at room temperature or only a few hundred ° C. above room temperature. The same may be true of almost all refractory metal oxides, nitrides and carbides. The BTD method may be, however, capable of producing polycrystalline or single-crystal films of numerous materials. According to one or more embodiments, one example route may be to deposit the materials as amorphous, then anneal them. Another example route may be to grow the materials on a heated substrate. In either case, it may be preferred to use the example reactive sputtering capabilities of BTD described above.

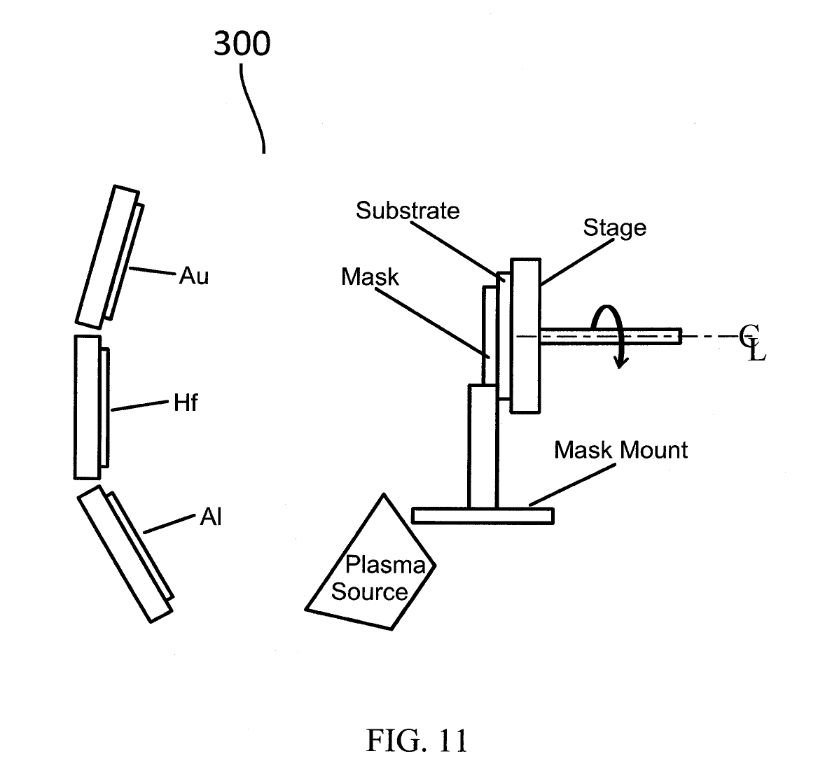

According to one or more embodiments, BTD may be used to make the capacitor insulator with a method of defining the patterns of material layers deposited. For example, a stencil lithography device may be mounted on the stage inside the BTD chamber to guide the geometry of the material deposition on the substrate. One example type of stencil mask may be integrated with the BTD system as shown in FIG. 11. With reference to FIG. 11, in BTD a plasma source floods an array of sputter targets with, in this example case, Ar⁺ or Ar⁺/O₂⁺ mixture plasma, which has high ion density but low ion kinetic energy, which may be too low to cause sputtering. In FIG. 11 are shown hafnium, aluminum and gold sputter targets, all of which may normally be illuminated simultaneously and continuously. For clarity various cross-contamination shields and shutters have been omitted. The targets may be electrically selected by applying negative bias to cause sputtering and hence deposition. This system has the capability of sputtering from three targets sequentially or simultaneously, with very rapid (e.g., <1 millisecond) electronic-only switching of the sputtering bias between the three targets, providing the capability of rapidly growing multilayer stacks.

According to one or more embodiments, to deposit a gold or other pure metal plate or electrode layer, only the Au target may be biased within an Ar⁺-only plasma. To deposit the nano-layered dielectric, both the Hf and Al targets may be exposed to an Ar⁺/O₂⁺ mixture plasma. Then negative bias is alternately applied to the Al and the Hf target to deposit appropriate amounts of Al₂O₃ and HfO₂. For these dielectrics, the target bias may be bi-polar pulsed voltages at ˜70 kHz with about 80% duty cycle at the high negative sputtering voltage and the remainder at a low positive voltage, to attract electrons from the plasma and neutralize any negative charge build-up on the face of the target. In addition, processes may limit or control process-induced intermixing of elements at interfaces, such as may be formed when depositing a layer 120 of high-k material (HfO₂) over top of a previously deposited additive (Al₂O₃) for an ultra-thin interface 110. According to one or more embodiments, HfO₂ may be deposited at low hafnium target voltages of −50 to −200 volts until two or three monolayers of HfO₂ have been deposited, then increase the hafnium target voltage to −500 to −5000 volts for faster deposition rate. Such voltage changes may be done by computer-controlled electronics in <1 μs time intervals. The lower target voltage results in only low kinetic energy species impacting the delicate ultra-thin interface 110 of Al₂O₃ additive material, which dramatically reduces atom or ion impact-induced damage and intermixing.

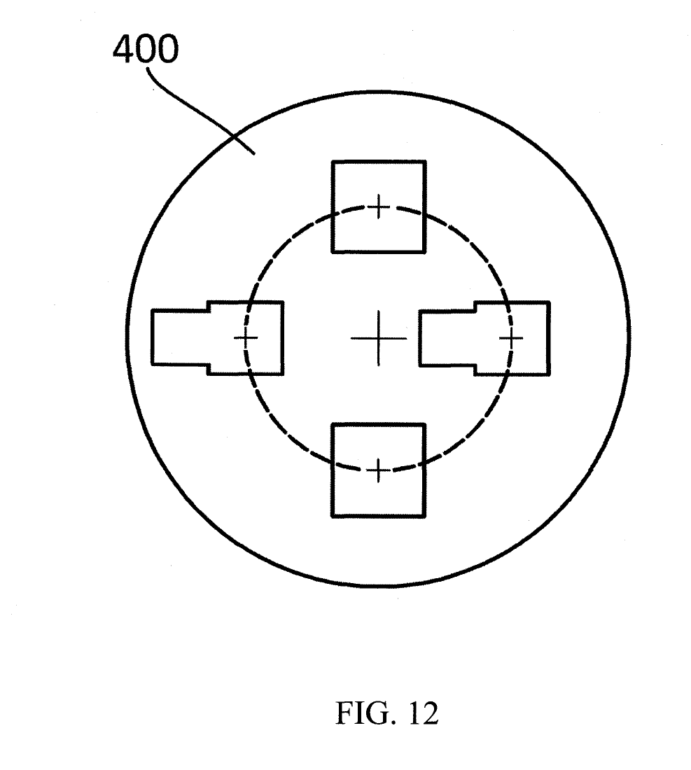

According to one or more embodiments, and referring at least to FIG. 11, there is shown a side-profile view an example substrate (e.g., a 100 mm diameter, thermally-oxidized silicon wafer, attached to a substrate stage). The stage may provide cooling for the substrate and one axis, as indicated, of motorized rotation with absolute rotary position sensing via an encoder. A fixed mask (e.g., shown in FIG. 12) with cut-outs to laterally define the metal and dielectric layers may be located e.g., 0.1-0.2 mm away from the front surface of the substrate.

According to one or more embodiments, and referring at least to FIG. 12, there is shown a front view of the stencil or deposition mask (white foreground) with cut-outs and a larger, shaded substrate behind the mask. In this example, the shapes of the cut-outs are more intended to illustrate the masked deposition method rather than form an example capacitor. The axis of rotation of the substrate may be perpendicular to the plane the mask and located at the cross-mark. The depicted orientation may be defined 0° (arbitrary).

According to one or more embodiments, metal plates or electrodes 220 and 240 may be deposited through smaller rectangular cut-outs with a side-notches (exaggerated in size for the sake of illustration) which forms the metal contacts and electrically joins together half of the interleaved metal plates on one side and half on the other side (nearest the rim and nearest the center, as seen in example FIG. 12). The capacitor insulator plural dielectric layer(s) with interfaces repeating unit structure 100 of FIG. 2 and FIG. 3, may be deposited through the larger, square openings. In the operating sequence, metal may be deposited to form the bottom-most plate with the stage/substrate fixed at, e.g., 0°. Then, the stage/substrate may be indexed to, e.g., 90° (either direction) and dielectric deposited, as described above, but with hundreds or thousands of Al/Hf oxide repeating units of the insulator 100 of FIG. 2. Then, the stage/substrate may be indexed to, e.g., 180° (same direction) and metal deposited to form another plate. Then, the stage/substrate may be indexed to, e.g., 270° (same direction) and insulator 100 deposited. Then, the stage/substrate may be indexed to, e.g., 360°=0° (same direction) and metal deposited to form another plate. Then this whole rotate-deposit-rotate sequence may be repeated dozens or hundreds of times, as desired, finishing with metal as the top-most plate.

According to one or more embodiments, the thin-film structures deposited may reside on, e.g., four patches on substrate 210. In the 0° position example shown in FIG. 12, capacitor 200 in FIG. 3 are the two patches on the “equator” of the substrate. The two patches on a vertical line may be unusable. The two capacitors 200, still on the Si/SiO2 substrate 210, may be sawed out of the 100 mm wafer as chips and the remainder discarded. After attaching wires to the gold contacts, the front face and edges of the chips may be passivated with a thick dielectric coating of, e.g., amorphous Al₂O₃ or other material, as desired. According to one or more embodiments, it may be possible to grind or etch away substrate 210. According to one or more embodiments, the chip capacitors may be “flip-chip” bonded onto a circuit board using solder balls, then may be under-filled with, e.g., epoxy resin and cured. This may provide mechanical strength and heat dissipation.

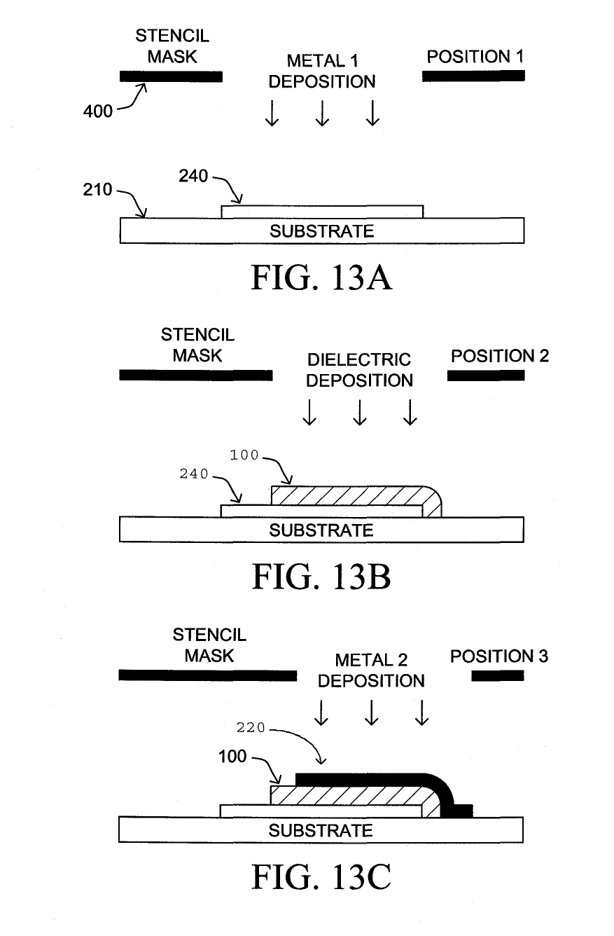

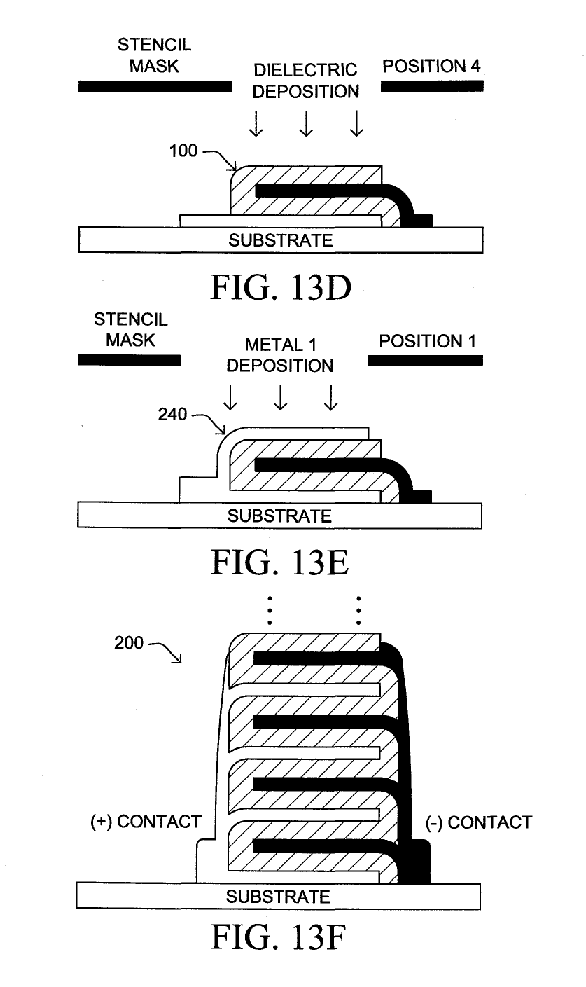

According to one or more embodiments, and referring at least to FIG. 13, there is shown the capacitor formed using the time sequence described above. For example, the stacked geometry may be created with stencil lithography using the time sequence displayed in FIG. 13 (a)-(e). The stencil mask may rotate, e.g., 90°, or the substrate may rotate, e.g., 90° under a fixed stencil mask, between each step (a) through (e). FIG. 13 (f) shows the material structure after several iterations of steps (b) through (e). Steps (b) through (e) may be repeated as necessary to fill the desired device depth. The material pointed out as 100 may represent the capacitor insulator structure at least of FIG. 2 or FIG. 3 and the materials shown as two different cross-hatch patterns may represent the electrode plates 220 and 240. The stencil shifts may create continuous metal and dielectric plates stacked together. The thickness of the material edges may be statistically predicted and controlled creating a sputtered atom drifting effect at the borders. Precise timing coordination of the BTD deposition process and the stencil shifts may be required to meet edge thickness requirements.

According to one or more embodiments, the example process of at least FIGS. 5-8 may be a room temperature process. No explicit heating of the substrate or growing capacitor need be provided. However, due to incidental heat or thermal radiation from electron or plasma sources, the substrate and capacitor temperate may rise several hundred degrees Centigrade over room temperature, less than 300° C. typically. In such a case, for example, substrate stage and optionally stencil mask may be water cooled.

According to one or more embodiments, gold may be used for the capacitor electrode plates. However, those skilled in the art will appreciate that other materials may be used.

One or more embodiments may be varied at least for making one or more insulator embodiments of the disclosure. For example, while BTD may be used because of size scalability and ultimate product cost for capacitors, those skilled in the art will recognize that other methods may also be used without departing from the scope of the disclosure.

According to one or more embodiments, methods of stencil lithography and the stencil masks may vary from the above described method. For example, it may be evident that large amounts of sputtered material are wasted in the method described herein, and two useless, discarded structures may also have been created. For manufacturing, according to one or more embodiments, elongated masks with linear travel may be used over rotary masks. It may also be efficient to have two separate BTD (or other) deposition chambers, e.g., one for the electrode plate conductors and one for the capacitor insulator.

According to one or more embodiments, one or more of the interfaces may increase k_{eff} of the capacitor insulator. For example, a test case of capacitor insulator 100 may be fabricated on a laboratory scale and tested for its properties. A wide-area bottom electrode 240 may be deposited by BTD sputter deposition (discussed above) of, e.g., tantalum metal on a prime-grade, polished silicon wafer. Amorphous Al₂O₃ may be chosen as the interface additive material for interfaces 110. Amorphous Ta₂O₅ may be chosen for the main dielectric layers 120. These materials may be very stable and rugged, easy to fabricate at ˜room temperature by BTD as fully dense, fully-oxidized, and atomically smooth materials, yet stable to high temperature (e.g., >500° C.). Their dielectric constants may be, e.g., ˜10 and ˜25, respectively, and values of, e.g., 10 and 25 may be used in the calculations above for k_{L} and k_{H}. According to one or more embodiments, approximate values of E_{bd} for these materials may be, e.g., ˜12 and ˜5 MV/cm, respectively. According to one or more embodiments, these may be theoretical values fit to a thermochemical model which may mimic measurements, though measurements of E_{bd} may not be reliable due to material variations and non-standardized measurement techniques. As an example insulator layers-and-interfaces structure, 4.5 repeat units may be deposited on the bottom electrode starting with a Ta₂O₅ layer 120, so the insulator layer/interface sequence may be H:L:H:L:H:L:H:L:H, where in the example H represents a-Ta₂O₅ 120 main dielectric layers and L represents a-Al₂O₃ 110 interface layers. This pattern may be similar to some of the examples used in the electrostatics derivation, above, and depicted at least in FIGS. 5 and 6. Each repeat unit may be fabricated to be nominally 10 nm thick, and four “L” interface 110 a-Al₂O₃ thickness cases may be chosen, e.g., 1 nm, 1.5 nm, 2 nm and 3 nm. The first four “H” main dielectric 120 a-Ta₂O₅ layer thicknesses may be chosen to complement these 110 thicknesses up to the 10 nm repeating unit thickness of 10 nm, which may give four cases of 9 nm, 8.5 nm, 8 nm and 7 nm.

The fifth “H” main dielectric 120 a-Ta₂O₅ layer thickness may be nominally 5 nm thick in each of the four cases, e.g., to keep the total insulator thickness at 44.5 nm +/−0.5 nm. After growth of the insulator stacks as stated, masked gold dots of about 0.2 mm² area may be evaporated onto the top a-Ta₂O₅ layer to make top electrodes 220, which all together may include test capacitors 200. These capacitors may be measured for capacitance value C at 10 kHz, 50 mV rms alternating current on, e.g., a Hewlett-Packard 4274A LCR meter, and values of the apparent dielectric constant k_{eff} may be calculated using the standard formula C=ε₀ k_{eff}A/d, where ε₀ is the permittivity of vacuum, k_{eff} is the average dielectric constant of the capacitor insulator, A is an area of the capacitor plates and d is the plate spacing.

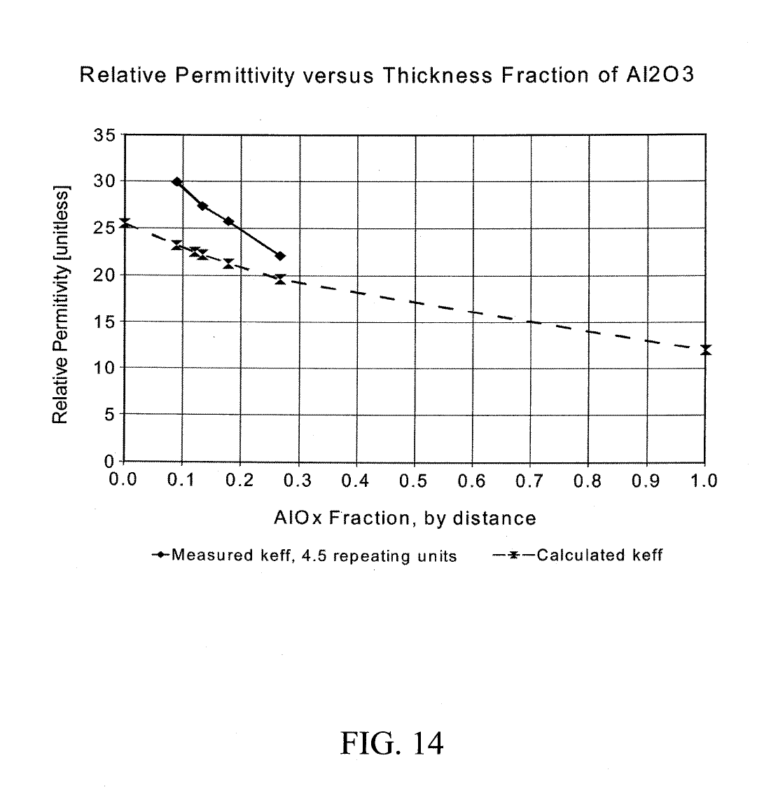

According to one or more embodiments, example results of these experiments and corresponding calculations done as shown above using standard zeroth-order semi-classical electrostatics are shown in FIG. 14. The horizontal axis is expressed in fraction of additive (low-k) material in terms of thickness (distance) within the whole stack, exactly as in FIGS. 7A and 8A, including the thickness of the fifth half-repeating-unit “H” layer of, e.g., 5 nm a-Ta₂O₅. The k values for pure a-Ta₂O₅ and a-Al₂O₃ may be estimated from example measurements of identical samples with the pure single material as the sole capacitor insulator, then these k values (e.g., 25.48 and 12.00, respectively) may be used for the k_{H} and k_{L} values in the calculated results presented. The results show consistently higher k_{eff} for the grown samples than may be expected from the calculation. For the 9 nm:1 nm repeating unit, the calculation may predict k_{eff} of ˜23.2 and the grown sample gives ˜30. These samples and results may be analyzed in more detail than presented herein, and an example interpretation is that the Al₂O₃ additive in the 1 nm and 1.5 nm cases of interface 110 is completely intermixing into the a-Ta₂O₅ neighboring 120 layers, while at least the 3 nm interface 110 is partially preserving its distinct identity as a-Al₂O₃ but also partly intermixing. In the intermixing zones, a known compound, AlTaO₄ may be formed in a disordered and possibly not 1:1 ratio of Al and Ta. The k value of this compound may be unknown, but may be higher than that of the a-Ta₂O₅, which is, e.g., 25.48. Estimates extracted from a reverse calculation using the above equations may indicate that the dielectric constant of this new material may be between 36 and 42, depending upon an estimate of its unknown thickness percentage in the stack. Therefore, one or more embodiments of the disclosure may be practiced to increase the k_{eff} of a capacitor insulator with an interface additive, wherein the resultant k_{eff} may be greater than the k_{H} of the main dielectric 120 and the k_{L} of the additive 110.

While one or more embodiments may be described in terms of a capacitor insulator, those skilled in the art will appreciate that other types of insulators may also be used without departing from the scope of the disclosure. As such, the description of a capacitor insulator should be taken as an example only and not to otherwise limit the scope of the disclosure. Additionally, while one or more embodiments may be described with reference to certain aspects of insulator performance, for example, breakdown, pre-breakdown, leakage and so forth, one skilled in the art will recognize that these concepts may entail many other phenomena and/or processes that may be implied in or possibly necessary for the practice of one or more embodiments of the disclosure without departing from the scope of the disclosure. As such, the description of breakdown, pre-breakdown, leakage and so forth should be taken as examples only and not to otherwise limit the scope of the disclosure. Additionally, while one or more embodiments may be described in terms of a “superlattice” structure, those skilled in the art will recognize that other structures may also be used without departing from the scope of the disclosure. As such, the description of a superlattice structure should be taken as an example only and not to otherwise limit the scope of the disclosure.

As will be appreciated by one skilled in the art, the present disclosure may be embodied as a method, system/apparatus, or computer program product (e.g., for the purposes of testing and/or manufacturing). Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer- usable program code embodied in the medium.

The present disclosure is described above of methods, apparatus (systems) and computer program products for testing and/or manufacturing according to embodiments of the disclosure. It will be understood that the above disclosure can be implemented by one or more computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for testing and/or manufacturing the functions/acts/apparatus specified in the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, and any combinations thereof will be apparent to those of ordinary skill in the art without departing from the scope and spirit of the disclosure. The embodiment(s) were chosen and described in order to best explain the principles of the disclosure and the practical application, and to enable others of ordinary skill in the art to understand the disclosure for various embodiment(s) with various modifications and/or any combinations of embodiment(s) as are suited to the particular use contemplated.

Having thus described the disclosure of the present application in detail and by reference to embodiment(s) thereof, it will be apparent that modifications, variations, and any combinations of embodiment(s) (including any modifications, variations, and combinations thereof) are possible without departing from the scope of the disclosure defined in the appended claims.

What is claimed is:

1. A capacitor comprising:
a first plate and a second plate;
an insulator between the first plate and the second plate, wherein the insulator includes a first dielectric layer and a second dielectric layer; and
at least one interface between the first dielectric layer and the second dielectric layer, wherein the at least one interface between the first dielectric layer and the second dielectric layer includes one or more additives.

2. The capacitor of claim 1 wherein the one or more additives include at least one of calcium, tungsten, magnesium, aluminum, tin, zinc, and strontium.

3. The capacitor of claim 1 wherein the one or more additives of the at least one interface are configured to achieve a +2 valence state and further configured to form a non-directional O-M-O bonding pattern.

4. The capacitor of claim 1 wherein the at least one interface is a floating conductor layer.

5. The capacitor of claim 1 wherein the at least one interface is a deceleration layer.

6. The capacitor of claim 5 wherein the deceleration layer is effective within a range of kinetic energy between 5-50 eV.

7. The capacitor of claim 1 wherein the at least one interface is at least one of an electron stopper layer, a cascade quenching layer, a leakage path blocking layer, a kinetic energy absorbing layer, an avalanche dissipating layer, carrier recombination layer, a trapped/free charge lateral bleed-off layer, an electron-hole recombination zone, an ion accumulation layer, an electron accumulation layer, and a hole accumulation layer.

8. The capacitor of claim 1 wherein the at least one interface is at least one of a conductive layer, an insulating layer, a semiconducting layer, a semi-insulating layer, a metallic layer, a semi-metallic layer, and a non-dielectric layer.

9. The capacitor of claim 1 wherein the at least one interface increases the average dielectric constant of the capacitor insulator.

10. The capacitor of claim 1 wherein the insulator includes a plurality of interfaces that are aperiodic in spacing.

11. The capacitor of claim 1 wherein a thickness of the at least one interface ranges from 0.1 nm-10 nm.

12. The capacitor of claim 1 wherein a spacing between one or more interfaces ranges from 5 nm-500 nm.

13. The capacitor of claim 1 wherein the insulator has a thickness configured to operate at at least one of 100 volts, 1000 volts, 10 k volts, and 100 k volts.

14. The capacitor of claim 1 wherein the at least one interface further includes, at least in part, one or more non-dielectric material layers.

15. The capacitor of claim 1 wherein the at least one interface further includes, at least in part, an intermixing of the at least one additive with at least one of the first dielectric layer and the second dielectric layer.

16. The capacitor of claim 15 wherein the intermixing further includes at least one of a chemical reaction, a resultant new material having chemical identity distinct from at least one of the first dielectric layer and the second dielectric layer, an interdiffusion, a resultant at least one concentration gradient, an interface transition zone/region, a resultant dielectric constant that is at least one of the same and different from that of at least one of the first dielectric layer and the second dielectric layer, one of a resultant electronic structure and set of electronic states distinct from that of at least one of the first dielectric layer and the second dielectric layer, and at least one of a resultant atomic vibration, phonon spectrum, and set of states different from that of at least one of the first dielectric layer and the second dielectric layer.

17. An apparatus comprising:
an insulator that includes a first dielectric layer and a second dielectric layer; and
at least one interface between the first dielectric layer and the second dielectric layer, wherein the at least one interface between the first dielectric layer and the second dielectric layer includes one or more additives.

18. The apparatus of claim 17 wherein the one or more additives include at least one of calcium, tungsten, magnesium, aluminum, tin, zinc, and strontium.

19. The apparatus of claim 17 wherein the one or more additives of the at least one interface are configured to achieve a +2 valence state and further configured to form a non-directional O-M-O bonding pattern.

20. The apparatus of claim 17 wherein the at least one interface is a floating conductor layer.

21. The apparatus of claim 17 wherein the at least one interface is a deceleration layer.

22. The apparatus of claim 21 wherein the deceleration layer is effective within a range of kinetic energy between 5-50 eV.

23. The apparatus of claim 17 wherein the at least one interface is at least one of an electron stopper layer, a cascade quenching layer, a leakage path blocking layer, a kinetic energy absorbing layer, an avalanche dissipating layer, carrier recombination layer, a trapped/free charge lateral bleed-off layer, an electron-hole recombination zone, an ion accumulation layer, an electron accumulation layer, and a hole accumulation layer.

24. The apparatus of claim 17 wherein the at least one interface is at least one of a conductive layer, an insulating layer, a semiconducting layer, a semi-insulating layer, a metallic layer, a semi-metallic layer, and a non-dielectric layer.

25. The apparatus of claim 17 wherein the at least one interface increases the average dielectric constant of the capacitor insulator.

26. The apparatus of claim 17 wherein the insulator includes a plurality of interfaces that are aperiodic in spacing.

27. The apparatus of claim 17 wherein a thickness of the at least one interface ranges from 0.1 nm-10 nm.

28. The apparatus of claim 17 wherein a spacing between one or more interfaces ranges from 5 nm-500 nm.

29. The apparatus of claim 17 wherein the insulator has a thickness configured to operate at at least one of 100 volts, 1000 volts, 10 k volts, and 100 k volts.

30. The apparatus of claim 17 wherein the at least one interface further includes, at least in part, one or more non-dielectric material layers.

31. The apparatus of claim 17 wherein the at least one interface further includes, at least in part, an intermixing of the at least one additive with at least one of the first dielectric layer and the second dielectric layer.

32. The apparatus of claim 31 wherein the intermixing further includes at least one of a chemical reaction, a resultant new material having chemical identity distinct from at least one of the first dielectric layer and the second dielectric layer, an interdiffusion, a resultant at least one concentration gradient, an interface transition zone/region, a resultant dielectric constant that is at least one of the same and different from that of at least one of the first dielectric layer and the second dielectric layer, one of a resultant electronic structure and set of electronic states distinct from that of at least one of the first dielectric layer and the second dielectric layer, and at least one of a resultant atomic vibration, phonon spectrum, and set of states different from that of at least one of the first dielectric layer and the second dielectric layer.

33. An apparatus comprising:
an insulator that includes a first dielectric body; and
at least one interface of the first dielectric body, wherein the at least one interface of the first dielectric body includes one or more additives.

34. The apparatus of claim 33 wherein the one or more additives include at least one of calcium, tungsten, magnesium, aluminum, tin, zinc, and strontium.

35. The apparatus of claim 33 wherein the one or more additives of the at least one interface are configured to achieve a +2 valence state and further configured to form a non-directional O-M-O bonding pattern.

36. The apparatus of claim 33 wherein the at least one interface is a floating conductor layer.

37. The apparatus of claim 33 wherein the at least one interface is a deceleration layer.

38. The apparatus of claim 37 wherein the deceleration layer is effective within a range of kinetic energy between 5-50 eV.

39. The apparatus of claim 33 wherein the at least one interface is at least one of an electron stopper layer, a cascade quenching layer, a leakage path blocking layer, a kinetic energy absorbing layer, an avalanche dissipating layer, carrier recombination layer, a trapped/free charge lateral bleed-off layer, an electron-hole recombination zone, an ion accumulation layer, an electron accumulation layer, and a hole accumulation layer.

40. The apparatus of claim 33 wherein the at least one interface is at least one of a conductive layer, an insulating layer, a semiconducting layer, a semi-insulating layer, a metallic layer, a semi-metallic layer, and a non-dielectric layer.

41. The apparatus of claim 33 wherein the at least one interface increases the average dielectric constant of the capacitor insulator.

42. The apparatus of claim 33 wherein the insulator includes a plurality of interfaces that are aperiodic in spacing.

43. The apparatus of claim 33 wherein a thickness of the at least one interface ranges from 0.1 nm-10 nm.

44. The apparatus of claim 33 wherein a spacing between one or more interfaces ranges from 5 nm-500 nm.

45. The apparatus of claim 33 wherein the insulator has a thickness configured to operate at at least one of 100 volts, 1000 volts, 10 k volts, and 100 k volts.

46. The apparatus of claim 33 wherein the at least one interface further includes, at least in part, one or more non-dielectric material layers.

47. The apparatus of claim 33 wherein the at least one interface further includes, at least in part, an intermixing of the at least one additive with the first dielectric body.

48. The apparatus of claim 47 wherein the intermixing further includes at least one of a chemical reaction, a resultant new material having chemical identity distinct from the first dielectric body, an interdiffusion, a resultant at least one concentration gradient, an interface transition zone/region, a resultant dielectric constant that is at least one of the same and different from that of the first dielectric body, one of a resultant electronic structure and set of electronic states distinct from that of the first dielectric body, and at least one of a resultant atomic vibration, phonon spectrum, and set of states different from that of the first dielectric body.
